(19) United States
(12) Patent Application Publication
(10) Pub. No.: US 2026/0252851 A1
(43) Pub. Date: Aug. 27, 2026

(54) METHOD AND APPARATUS FOR DETERMINING PHYSICAL STATE OF AN OBJECT

(71) Applicant: Robert Bosch GmbH, Stuttgart (DE)

(72) Inventors: Ze Cheng, Shanghai (CN); Xiaoqiang Wang, Shanghai (CN); Xu Xie, Shanghai (CN); Zhongkai Hao, Shanghai (CN)

(21) Appl. No.: 19/537,843

(22) Filed: Feb. 12, 2026

(30) Foreign Application Priority Data
Feb. 25, 2025 (CN) 2025 1 0219536.0

(51) Int. Cl. G06N 3/0455; G06F 17/16; G06N 3/0985

(52) U.S. Cl. CPC G06N 3/0455; G06F 17/16; G06N 3/0985

(57) ABSTRACT

A computer-implemented method for determining the physical state of an object having a shape. The method includes: receiving first structural data representing a first shape of an object; generating a first feature sequence comprising N feature vectors based on first structural data; converting the first feature sequence into a second feature sequence comprising M feature vectors; performing Fourier transform-based processing on the second feature sequence to obtain a third feature sequence comprising M feature vectors; converting the third feature sequence into a fourth feature sequence comprising N feature vectors; and determining first physical state data representing the physical state of the object having the first shape based on the fourth feature sequence.

### CROSS REFERENCE

The present application claims the benefit under 35 U.S.C. § 119 of China Patent Application No. 2025 1 0219536.0 filed on Feb. 25, 2025, which is expressly incorporated herein by reference in its entirety.

### FIELD

The present disclosure relates to artificial intelligence techniques, and more particularly, to methods and apparatuses for determining the physical state of an object, methods and apparatuses for structural optimization of an object, and methods and apparatuses for training a neural network model.

### BACKGROUND INFORMATION

The structure of an object, such as its shape, size, or material distribution, affects the performance of the object. An example of an object may be a wing of an aircraft, a duct in a reactor, a housing of a vehicle, or the like. For example, the shape of the wing may affect the pressure and speed of airflow relative to the wing, which in turn may affect the performance of the physical system of the wing. The physical system of an object can be described by partial differential equations (PDEs). By solving PDEs based on structural data, physical data of the physical system, such as pressure and velocity, can be obtained.

In the process of structural optimization, the structure of an object is designed to improve its performance. Structural optimization is used in a variety of fields, including science, engineering, industry, and the like. For example, the shape of a product (such as chemical catalyst particles, automotive parts, etc.) may be optimized by a structural optimization process prior to manufacturing the product.

Because most physical systems are described by PDEs, relevant PDEs can be utilized for structural optimization, e.g., relevant constraint PDEs can be solved in each iteration of structural optimization to determine the physical state of the current structure. For the structural optimization of objects, especially for objects with complex structures, the efficiency and accuracy of solving related constraint PDEs are crucial to improving the performance of structural optimization.

Neural network (NN) models used to solve PDEs have the advantage of fast inference speed, which can reduce computing costs while maintaining good accuracy. Compared to numerical solvers used to solve PDEs, using NN models to predict solutions to constraint PDEs and optimizing the structure of an object based on the predicted solutions to PDEs can significantly accelerate the structural optimization process constrained by PDEs. However, due to errors in the NN model prediction results and the accumulation of errors in the resulting structural optimization, deviations may occur in the structural optimization process.

### SUMMARY

The following introduction is provided in order to introduce selected concepts of the present disclosure in a simple manner, and these concepts will be further described in the detailed description below. The introduction is not intended to highlight the key or necessary features of the present disclosure, nor is it intended to limit the scope of the present disclosure.

To address the above problems, according to one aspect of the present disclosure, a computer-implemented method for determining the physical state of an object having a shape is provided. According to an example embodiment, the method comprises: receiving first structural data representing a first shape of the object; generating a first feature sequence comprising N feature vectors based on the first structural data; converting the first feature sequence into a second feature sequence comprising M feature vectors; performing Fourier transform-based processing on the second feature sequence to obtain a third feature sequence comprising M feature vectors; converting the third feature sequence into a fourth feature sequence comprising N feature vectors; and determining first physical state data representing the physical state of the object having the first shape based on the fourth feature sequence.

According to one aspect of the present disclosure, a computer-implemented method for structural optimization of an object is provided. According to an example embodiment, the method comprises iteratively performing the following steps: receiving first structural data representing a first shape of the object; predicting first physical state data representing a physical state of the object having the first shape using the method according to various examples of the present disclosure; and updating the first structural data based on the first physical state data to obtain updated first structural data representing an updated first shape of the object.

According to one aspect of the present disclosure, a computer-implemented method for training a neural network model for determining the physical state of an object having a shape is provided, wherein the neural network model comprises a virtual Fourier layer, the virtual Fourier layer comprising a first transformation layer, a Fourier processing layer, and a second transformation layer. According to an example embodiment, the method comprises: receiving first structural data representing a first shape of a first object and first labeled physical state data representing the physical state of the first object having the first shape; generating a first feature sequence comprising N feature vectors based on the first structural data; converting the first feature sequence into a second feature sequence comprising M feature vectors through the first transformation layer; performing Fourier transform-based processing on the second feature sequence through the Fourier processing layer to obtain a third feature sequence comprising M feature vectors; converting the third feature sequence through the second transformation layer into a fourth feature sequence comprising N feature vectors; determining first predicted physical state data representing the physical state of the first object having the first shape based on the fourth feature sequence; and updating learnable parameters of the neural network model based on the first predicted physical state data and the first labeled physical state data.

According to one aspect of the present disclosure, a computer-implemented method for structural optimization of an object is provided. According to an example embodiment, the method comprises iteratively performing the following steps: receiving first structural data representing a first shape of the object; when a first condition is met, determining first calibration physical data representing a physical state of the object having the first shape based on the first structural data by a numerical solver, wherein the first calibration physical data is used as first physical data representing a physical state of the object having the first shape, or the first calibration physical data is used as reference physical data for a first neural network model to predict first physical data representing a physical state of the object having the first shape; when the first condition is not met, determining first physical data representing a physical state of the object having the first shape based on the first structural data, reference structural data representing a reference shape of the object, and reference physical data representing a physical state of the object having the reference shape by the first neural network model; and updating the first structural data of the object based on the first physical data to obtain updated first structural data representing an updated first shape of the object.

According to one aspect of the present disclosure, an apparatus for determining the physical state of an object having a shape is provided. According to an example embodiment, the apparatus comprises: a generation module for generating a first feature sequence comprising N feature vectors based on first structural data representing a first shape of the object; a virtual Fourier module for converting the first feature sequence into a second feature sequence comprising M feature vectors, performing Fourier transform-based processing on the second feature sequence to obtain a third feature sequence comprising M feature vectors, and converting the third feature sequence into a fourth feature sequence comprising N feature vectors; and a determination module for determining first physical state data representing the physical state of the object having the first shape based on the fourth feature sequence.

According to one aspect of the present disclosure, an apparatus for structural optimization of an object is provided. According to an example embodiment, the apparatus comprises: a physical state data determination module for determining first physical state data representing a physical state of the object having a first shape based on first structural data representing a first shape of the object by means of the method according to various examples of the present disclosure; and a structure update module for updating the first structural data based on the first physical state data to obtain updated first structural data representing an updated first shape of the object.

According to one aspect of the present disclosure, an apparatus for training a neural network model for determining the physical state of an object having a shape is provided. According to an example embodiment, the apparatus comprises: a processing module comprising the neural network model, which receives first structural data representing a first shape of a first object and first labeled physical state data representing the physical state of the first object having the first shape; generates a first feature sequence comprising N feature vectors based on the first structural data; converts the first feature sequence into a second feature sequence comprising M feature vectors; performs Fourier transform-based processing on the second feature sequence to obtain a third feature sequence comprising M feature vectors; converts the third feature sequence into a fourth feature sequence comprising N feature vectors; and determines first predicted physical state data representing the physical state of the first object having the first shape based on the fourth feature sequence; and an update module, which updates learnable parameters of the neural network model based on the first predicted physical state data and the first labeled physical state data.

According to one aspect of the present disclosure, an apparatus for structural optimization of an object is provided. According to an example embodiment, the apparatus comprises: a physical state determination module for receiving first structural data representing a first shape of the object; when a first condition is met, determining first calibration physical data representing a physical state of the object having the first shape based on the first structural data by a numerical solver, wherein the first calibration physical data is used as first physical data representing a physical state of the object having the first shape, or the first calibration physical data is used as reference physical data for a first neural network model to predict first physical data representing a physical state of the object having the first shape; and when the first condition is not met, determining first physical data representing a physical state of the object having the first shape based on the first structural data, reference structural data representing a reference shape of the object, and reference physical data representing a physical state of the object having the reference shape by the first neural network model; and a structure update module for updating the first structural data of the object based on the first physical data to obtain updated first structural data representing an updated first shape of the object.

According to one aspect of the present disclosure, a processing apparatus is provided. According to an example embodiment, the processing apparatus comprises: one or more processors; and one or more memories, the memories having computer-executable instructions stored thereon, and the instructions, when run by the one or more processors, performing the method according to the examples of the present disclosure.

According to one aspect of the present disclosure, a machine-readable storage medium is provided, executable instructions are stored on the machine-readable storage medium, and the instructions, when executed, cause one or more processors to perform the method according to the examples of the present disclosure.

According to one aspect of the present disclosure, a computer program product is provided, comprising executable instructions, and the instructions, when executed, cause one or more processors to perform the method according to the examples of the present disclosure.

The technical solution according to various aspects of the present disclosure employs a virtual Fourier layer in the NN model for solving the PDE to enhance the derivative learning capabilities of the NN model, thereby enabling the physical data predicted by the NN model in the gradient-based structural optimization process to have smaller deviations with respect to the derivative, thereby improving the performance of the gradient-based structural optimization. The technical solution according to various aspects of the present disclosure uses a hybrid inference method combining neural operators and numerical solvers in the process of structural optimization, thereby inhibiting error accumulation and controlling deviations from the optimization trajectory. Other advantages of the technical solution of the present disclosure will be described below.

### BRIEF DESCRIPTION OF THE DRAWINGS

The nature and advantages of the content of the present disclosure may be further implemented by referring to the figures. In the figures, similar components or features may have the same reference signs.

FIG. 1 shows an exemplary process and framework for optimizing the structure of an object according to one example.

FIG. 2 shows a schematic diagram illustrating the effect of accumulated error on a gradient-based structural optimization process utilizing neural operators according to one example.

FIG. 3 shows a schematic process of a method for training an NN model according to one example.

FIG. 4 shows an exemplary comparison between a general neural operator and a reference neural operator according to one example.

FIGS. 5A to 5D show exemplary model architectures of reference neural operators according to one example.

FIGS. 5E and 5F show exemplary structures of integral operator layers according to one example.

FIG. 6 shows an exemplary schematic diagram for determining the geometric deformation of a query domain relative to a reference domain according to one example.

FIGS. 7A and 7B show schematic diagrams of a process for structural optimization of an object according to one example.

FIGS. 8 and 9 show exemplary schematic diagrams of objects and physical systems thereof according to one example.

FIG. 10 shows a method for determining the physical state of an object having a shape according to one example.

FIG. 11 shows a method for structural optimization of an object according to one example.

FIG. 12 shows a method for training an NN model for determining the physical state of an object having a shape according to one example.

FIG. 13 shows a method for structural optimization of an object according to one example.

FIG. 14 shows an apparatus for determining the physical state of an object having a shape according to one example.

FIG. 15 shows an apparatus for structural optimization of an object according to one example.

FIG. 16 shows an apparatus for training an NN model for determining the physical state of an object having a shape according to one example.

FIG. 17 shows an apparatus for structural optimization of an object according to one example.

FIG. 18 shows a block diagram of a processing apparatus according to one example.

### DETAILED DESCRIPTION OF EXAMPLE EMBODIMENTS

The subject matter described herein will now be discussed with reference to exemplary embodiments. It should be understood that discussions about these embodiments are provided to aid those skilled in the art in better understanding and thereby implementing the subject matter described herein rather than limiting the scope of protection, applicability, or examples disclosed herein.

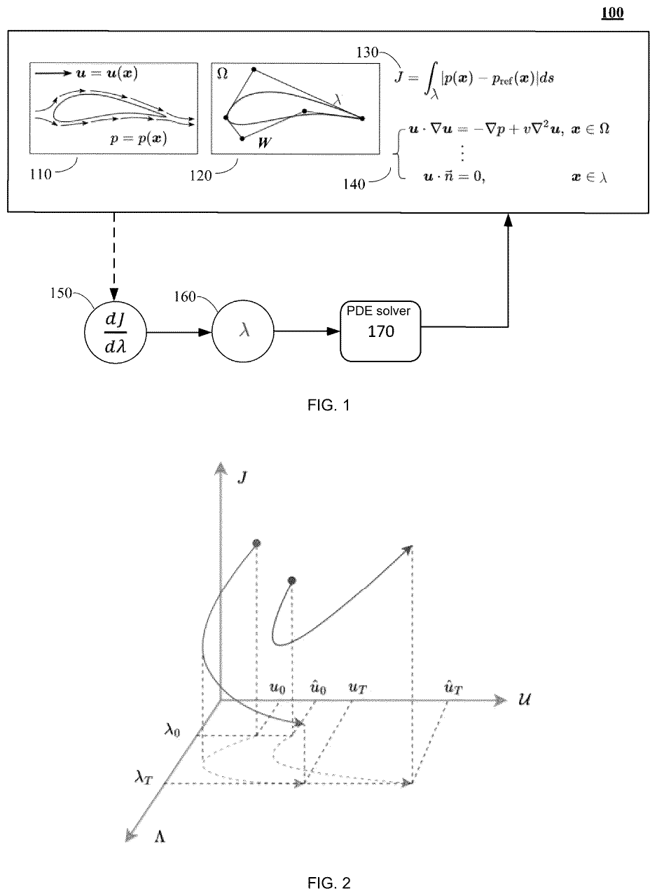

FIG. 1 shows an exemplary process and framework for optimizing the structure of an object according to one example.

In the example shown in FIG. 1, the object to be structurally optimized is a wing of an aircraft. As shown in block 120, the shape of the wing is represented by the boundary λ, which is parameterized by the structural data W. In this example, the structural data W may be a set of control points forming a spline curve representing the shape of the wing. In other words, the structure to be optimized is the shape of the wing represented by the spline curve with a set of control points W. The marker Ω represents the problem domain, more specifically the geometric space of the physical system associated with the wing having a particular shape. It will be understood that the structural data W is a discretized representation of the boundary λ. The two are equivalent to representing the shape of an object. Therefore, in this paper, the two are no longer strictly distinguished, but the structural data of the object's shape is usually represented by the symbol λ.

As shown in block 110, the arrowed lines represent airflow over the wing. The physical state of airflow over the wing may be represented by physical data from the physical system associated with the wing. In this example, the physical data may be velocity u=u(x) and pressure p=p(x). The symbol x indicates the spatial coordinates in the domain Ω.

As shown in 140, the relationship between velocity u=u(x) and pressure p=p(x), as well as the shape of the wing represented by the boundary λ, can be characterized by a PDE. It will be understood that PDEs are a known set of physical equations that can be used to describe the three-dimensional motion of viscous fluid substances. Second-order PDEs can be used to model weather, ocean currents, thermal conduction, airflow around wings, and water flow in pipes or reactors in and many other applications. The PDE used to characterize the physical system can be obtained based on the physical laws associated with the physical system of the object. As shown in 140 of FIG. 1, the physical system PDE characterizing the wing can be obtained based on the physical laws related to the pressure and velocity of the airflow. Because these PDEs are used to control the optimization of the structure of the wing during the structural optimization process, they can be referred to as control or constraint PDEs.

As shown by the label 130 in FIG. 1, the objective of wing structure optimization is to achieve the desired pressure distribution on the surface of the wing by changing the structural parameters W or λ. The objective function J may be formulated in the manner indicated by the label 130, and the objective of the structural optimization is to minimize the objective function J. In this case, the objective function J is a function of pressure p. The wing shape corresponding to the boundary λ, which is parameterized by the structural data W, may be optimized iteratively to minimize the objective function J to achieve the desired pressure distribution on the surface of the wing.

The PDE-constrained structural optimization problem illustrated in 130 and 140 of FIG. 1 can be generally expressed as Equation

$${min}_{λ ∈ Λ} \hat{J} ( λ ) \qquad ( 1 )$$

$$const . 𝒞 ( u , λ ) = 0$$

wherein, const. represents constraint, λ represents structural space, which can also be design space, such as high-dimensional design space, the objective function is defined as Ĵ(λ):=J((u(λ),λ)), such as the objective function shown by 130 in FIG. 1, and C(u,λ) represents the constraint PDE, such as the constraint PDE shown by 140 in FIG. 1.

The gradient-based structural optimization method seeks the gradient of the objective function with respect to the design parameters, often referred to as sensitivity, as shown in Equation (2)

$$\frac{\partial \hat{J}}{\partial λ} = \frac{\partial J}{\partial u} \frac{\partial u}{\partial λ} + \frac{\partial J}{\partial λ} \qquad ( 2 )$$

In each iteration of structural optimization, the structural parameters or design parameters λ can be updated iteratively via

$${λ}_{t + 1} ← {λ}_{t} - η \frac{\partial \hat{J}}{\partial λ} ,$$

where η represents the learning rate.

Returning to the example in FIG. 1, PDE solver 170 solves PDE 140 based on the current structural data λ=λₜ to determine the corresponding physical data u=u(λ), in which case the physical data u comprises velocity u=u(x) and pressure p=p(x). After determining the current value J=J((u(λ), λ) of the objective function at 130, for example, using Equation (2) at 150, the gradient

$$δ J = \frac{d J}{d λ} = \frac{d J ( ( u ( λ ) , λ )}{d λ}$$

of the objective function J for structural optimization with respect to the structural data λ is determined. Then, updated structural data

$$λ = {λ}_{t + 1} ← {λ}_{t} - η \frac{\partial \hat{J}}{\partial λ}$$

is obtained at 160. The above optimization process is performed iteratively to obtain optimized object structure data λ. The PDE solver 170 can be implemented using traditional numerical solvers (such as the finite element method (FEM)) or using an NN model (also known as a neural operator). Numerical solvers can accurately solve for the physical parameters of PDEs, but the problem is that they require a large amount of computation and time. For example, the large-scale numerical computation required to solve PDEs may cause the structural optimization process to take hours or even days to converge to the optimal design. The neural operator implemented through the NN model learns the mapping from geometric space to PDE solution space (G-S), where G represents geometry and S represents solution. Therefore, it can predict PDE solutions much faster, e.g., bringing orders of magnitude of time reduction to the structural optimization process, thus having an advantage in the structural design of objects. However, the use of the NN model to implement the PDE solver 170 is likely to cause deviations in the structural optimization process.

For example, for a trained NN model as represented by Equation (3)

$${𝒢}_{θ} : Λ ↦ 𝒰 \qquad ( 3 )$$

$$λ ↦ u$$

where θ represents the learning parameters of the NN model and λ and [symbol] represent the structure space and solution space, respectively, then the gradient calculation shown in Equation (2) is expressed as

$$\frac{\partial \hat{J}}{\partial λ} = \frac{\partial J}{\partial u} \frac{\partial {𝒢}_{θ}}{\partial λ} + \frac{\partial J}{\partial λ} .$$

This may present some problems: First, the difference between the predicted solution [symbol] and the true solution u in the NN model leads to a difference between the objective function values J( [symbol] ) and J(u); second, similarly, this leads to an error between the gradient

$$\frac{\partial {𝒢}_{θ}}{\partial λ}$$

and the true gradient

$$\frac{\partial u}{\partial λ} ;$$

third, through a plurality of iterations of the gradient-based structural optimization process, these errors accumulate continuously, which may cause the optimization trajectory to enter the out-of-distribution (OoD) region of the neural operator, resulting in unreliable predictions from the neural operator and deviations from the structural optimization process.

FIG. 2 shows a schematic diagram illustrating the effect of accumulated error on a gradient-based structural optimization process utilizing a neural operator 170. In the figure, λ, u, and û represent the input structural data of the neural operator 170, the output solution prediction, and the truth value of the solution, respectively. The arrowed curve on the left side of FIG. 2 is the structural optimization trajectory or process utilizing the neural operator 170. The arrowed curve on the right is a structural optimization trajectory based on the true solution. It can be seen from the comparison of the two trajectories that the structural optimization trajectory using the neural operator 170 deviates significantly from the initial point (λ₀, u₀) to the final optimization point (λ_{T}, u_{T}), and its cumulative error is out of control.

The technical solution of the present disclosure addresses the above problems from several aspects: first, enabling the NN model to effectively learn the gradient of the optimization objective with respect to the structure; second, effectively sampling and utilizing near-optimal data; and third, controlling the cumulative error of the neural operator during the optimization process. According to a first aspect, the technical solution of the present disclosure introduces a virtual physical layer in the NN model to enhance the gradient learning capability of the neural operator. According to a second aspect, the technical solution of the present disclosure uses data from historical optimization trajectories in various structural optimization projects as a training set. Additionally, according to a further aspect, in order for the NN model to more effectively learn from these training data, the technical solution of the present disclosure uses an NN model architecture of a reference neural operator (RNO). Furthermore, by introducing a virtual physical layer into the RNO model architecture, the gradient of the structural optimization objective with respect to the structure can be effectively learned using historical optimization trajectories from various structural optimization projects. According to a third aspect, the technical solution of the present disclosure uses a hybrid inference method combining neural operators and numerical solvers in the process of structural optimization, thereby inhibiting error accumulation and controlling deviations from the optimization trajectory. It will be understood that the above three aspects can solve or mitigate the problem of deviation or loss of control of the optimization trajectory shown in FIG. 2, either individually, in partial combination, or in full combination. In a certain example of the present disclosure, it is not necessary to include all of the above aspects. Furthermore, the advantages of the technical solution of the present disclosure are not limited to the above three aspects. Other advantages will be introduced in the following description.

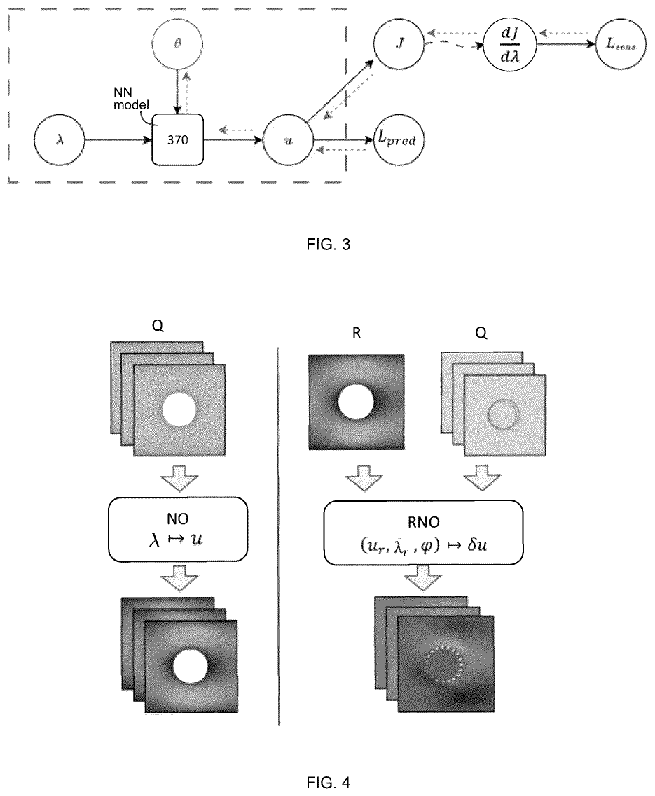

FIG. 3 shows a schematic process of a method for training an NN model according to one example.

The NN model 370 with learning parameters θ is, e.g., the neural operator 170 shown in FIG. 1, whose input is spatial structure data λ and whose output is physical data u as a solution to the PDE. Since the gradient of the NN model 370 is critical for gradient-based structural optimization, derivative learning is implemented for the NN model 370. Sensitivity is defined by Equation (2), and derivative learning means applying supervision over the sensitivity of the NN model 370. For a gradient-based structural optimization trajectory in the training dataset (e.g., the gradient-based structural optimization process determines the PDE solution through a numerical solver, or the optimization result of the gradient-based structural optimization process is a verified optimal result), given samples in this structural optimization trajectory, including the input structural data λ and the corresponding ground truth value of the PED solution û, the optimization objective ground truth value Ĵ, and the ground truth value [symbol] of the gradient of the optimization objective with respect to the structural data (here, .\hat{ }represents a quantity with a ground truth value), a sensitivity loss Lₛₑₙₛ can be applied to the NN model 370

$${L}_{s e n s} = ‖ {∇}_{λ} J ( {𝒢}_{θ} , λ ) - \text{?} ‖ \qquad ( 4 )$$

where [symbol] represents the PDE solution u predicted by the NN model 370 based on input data λ and [symbol] represents the derivative of the optimization objective J with respect to the structural data λ.

The predicted loss for the NN model 370 is L_{pred}=∥ [symbol] −û∥, and therefore the total loss is:

$$L = {L}_{p r e d} + α {L}_{s e n s} \qquad ( 5 )$$

where α>0 is a hyperparameter used to control the weight of the sensitivity loss.

As shown by the dashed line in FIG. 3, the model parameters θ are updated based on the loss L during the model training process. Any appropriate model parameter optimization method can be employed to update the parameters θ of the model based on the loss L, e.g., by using the Adam algorithm to update the parameters θ of the model. It will be understood that the model training process shown in FIG. 3 is applicable to a variety of neural operators, including the reference neural operators (RNOs) described below.

FIG. 4 shows an exemplary comparison between a general neural operator (NO) and a reference neural operator (RNO) according to one example.

As shown on the left side of FIG. 4, the general neural operator NO maps geometry/structural data λ directly to the solution u of the PDE, which typically requires a large amount of data to cover a variety of geometries for the neural operator to learn this mapping relationship. As shown on the right side of FIG. 4, the RNO does not predict PDE solutions for arbitrary geometries like G-S, but rather predicts the amount of change δu of the PDE solution given a reference geometry λᵣ and a reference design of the reference solution uᵣ. The rationale behind this is that similar variations in different geometries have similar effects on the solutions of PDEs. For example, consider fluid flow within a perforated channel. Regardless of the number of holes in the channel, enlarging, shrinking, or moving the hole near the channel inlet will have a similar effect on the fluid. RNOs are able to predict changes in solutions due to variations in geometry.

Specifically, as shown on the right side of FIG. 4, RNOs take the reference solution uᵣ, the corresponding reference geometry λᵣ, and the shape change φ of the query geometry λ_{q} compared to the reference geometry as input, and output a prediction δu of the solution change between the reference solution and the query solution. The predicted solution u_{q} for the query geometry λ_{q} may then be obtained based on the reference solution uᵣ and the solution change δu. The RNO shown on the right side of FIG. 4 can be represented by Equation (6)

$${𝒢}_{θ} : Λ \times 𝒰 \times 𝒯 \to 𝒰 \qquad ( 6 )$$

$$( {λ}_{r} \times {u}_{r} \times φ ) \to δ u$$

where θ represents the learning parameters of the NN model, Λ and [symbol] represent the structure space and solution space respectively, and [symbol] = [symbol] (Λ), s≥1 represents the deformation on the structure space Λ, that is, the deformation between the reference geometry λᵣ and the query geometry λ_{q}.

It will be understood that the mapping relationship shown in Equation (6) is not the only implementation of the RNO. In another example, the RNO may be implemented as shown in Equation (7)

$${𝒢}_{θ} : Λ \times 𝒰 \times 𝒯 \to 𝒰 \qquad ( 7 )$$

$$( {λ}_{q} \times {u}_{r} \times φ ) \to {u}_{q}$$

In the RNO shown in Equation (7), the RNO takes the query geometry λ_{q}, the reference solution uᵣ, and the shape transformation φ between the query geometry λ_{q} and the reference geometry λᵣ as input, and outputs the predicted solution u_{q}. In this example, because there are skip connections in the residual structure of the neural network, the solution change δu can be indirectly learned by setting u_{q} as the prediction target of the NN model. Thus, in practical applications, u_{q} can be directly used as the prediction target of the NN model, which simplifies the implementation process. With this modification, the RNO can be reinterpreted as an extension of the ordinary neural operator from [symbol] : Λ→ [symbol] to [symbol] : Λ× [symbol] × [symbol] → [symbol] . This extension is key to improving the effectiveness of RNO learning, as it enables learning from the intrinsic relationships between solution data.

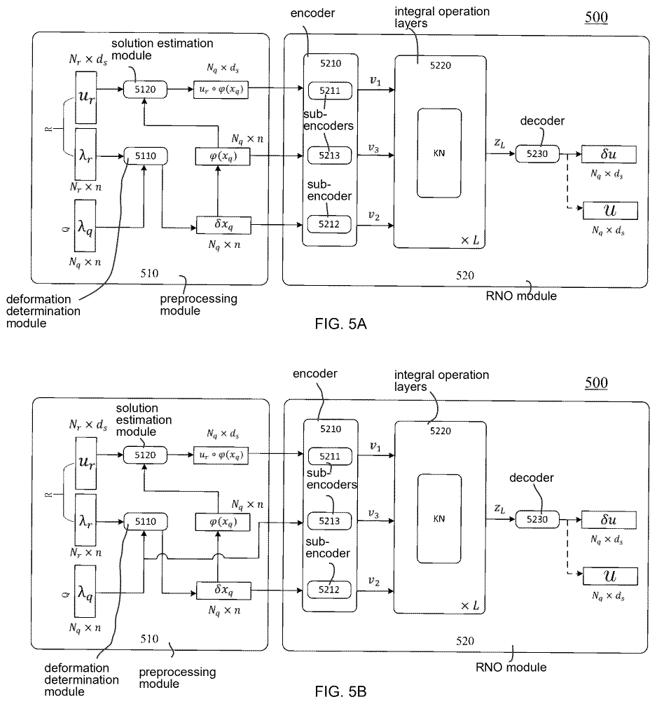

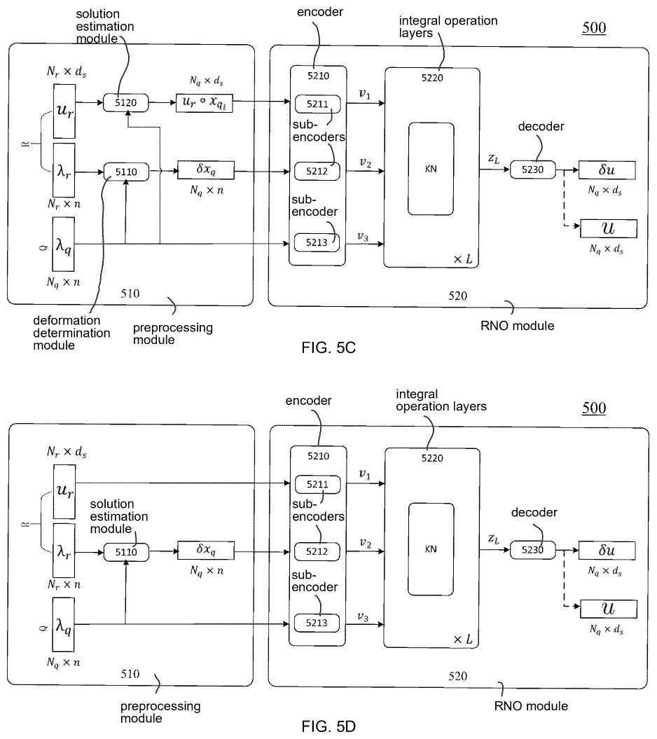

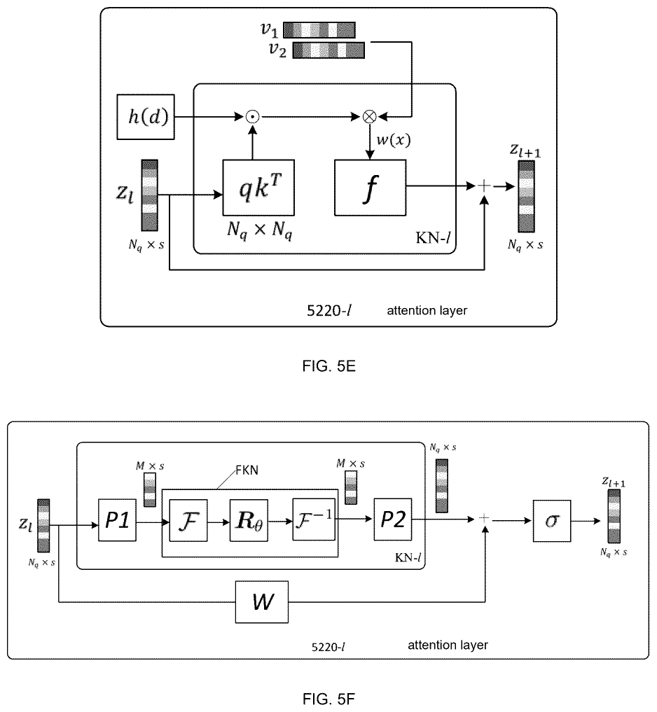

FIG. 5A shows an exemplary model architecture of an RNO according to one example. For ease of illustration, in FIG. 5A, rounded rectangles are used to represent processing units and right-angled rectangles are used to represent data.

The model architecture 500 comprises a preprocessing module 510 and an RNO module 520. The preprocessing module 510 preprocesses the input data, the input data comprising query data Q and reference data R. The query data Q comprises the structural data

$${λ}_{q} = {\{ {x}_{{q}_{i}} \}}_{i = 1}^{{N}_{q}} ,$$

where x_{q}_{ᵢ} is the coordinates of a point qᵢ in the query structure domain λ_{q}. For example, for a one-dimensional domain, x_{q}_{ᵢ} represents a one-dimensional value; for a two-dimensional domain, x_{q}_{ᵢ} represents a two-dimensional value pair; for a three-dimensional domain, x_{q}_{ᵢ} represents a three-dimensional value triple; generally, for an n-dimensional domain, x_{q}_{ᵢ} represents an n-dimensional value tuple. Reference data R comprises reference structural data

$${λ}_{r} = {\{ {x}_{{r}_{i}} \}}_{i = 1}^{{N}_{r}} ,$$

where xᵣ is a coordinate of a point rᵢ in the reference domain λᵣ and comprises a reference solution

$${u}_{r} = {\{ u ( {x}_{{r}_{i}} ) \}}_{i = 1}^{{N}_{r}} ,$$

where u(xᵣ_{ᵢ}) is a solution at the point xᵣ_{ᵢ}, which can be dₛ-dimensional. For example, if the solution to the PDE comprises three physical quantities, such as velocities u1 and u2 and pressure p, then u(xᵣ_{ᵢ}) is a three-dimensional value triple. In one example, the input sequences uᵣ, λᵣ, and λ_{q} are tensors of shapes Nᵣ×dₛ, Nᵣ×n, and N_{q}×n, respectively.

The preprocessing module 510 comprises a deformation determination module 5110 that determines the geometric deformation φ of the query structure domain λ_{q} relative to the reference domain λᵣ based on the input structural data

$${λ}_{r} = {\{ {x}_{{r}_{i}} \}}_{i = 1}^{{N}_{r}} and {λ}_{q} = {\{ {x}_{{q}_{i}} \}}_{i = 1}^{{N}_{q}} .$$

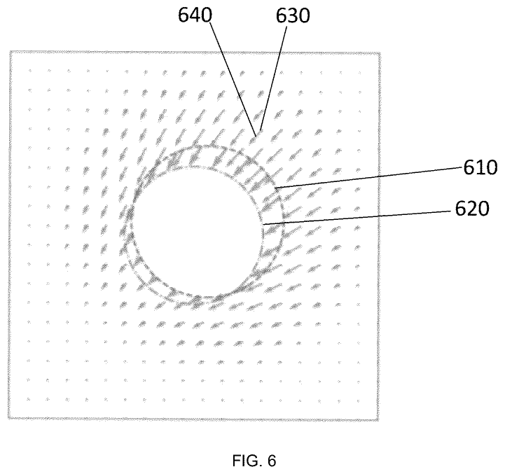

FIG. 6 shows an exemplary schematic diagram for determining the geometric deformation of a query domain relative to a reference domain according to one example.

The boundaries 610 and 620 are the boundaries of the query domain λ_{q} and the reference domain λᵣ, respectively. Refer to the example in FIG. 5A, where the query domain λ_{q} and the reference domain λ contain discrete points

$${\{ {x}_{{q}_{i}} \}}_{i = 1}^{{N}_{q}} and {\{ {x}_{{r}_{i}} \}}_{i = 1}^{{N}_{r}} ,$$

respectively. To construct the geometric deformation φ of the query domain relative to the reference domain, the displacement vectors from points on the query domain boundary 610 to corresponding points on the reference domain boundary 620 can first be determined, as shown by the vector from circle 610 to circle 620; then, based on the displacement vectors of the points on the boundary, the displacement vectors of all points in the query domain can be determined.

The displacement vector between the boundaries 610 and 620 may be determined by any suitable method. For example, the displacement vectors between domain boundaries may be determined using boundary data representing the domain boundaries. The boundary data may be geometric parameters. In this example, the geometric parameters may be the center and radius of the circle. Using a matching method, the displacement vector between the two circles 610 and 620 can be found based on the center and the coordinates of points on the circle. The boundary data may also be a set of boundary points. Accordingly, by using a matching method, the displacement vector can be found between the boundary points of the two circles 610 and 620.

After obtaining the displacement vector between the two circles 610 and 620, for each point x_{q}_{ᵢ} 630 in the query domain, the displacement vector of the boundary point closest to point x_{q}_{ᵢ} 630 on the boundary 610 is selected, and the displacement vector is weighted according to the distance between point x_{q}_{ᵢ} 630 and its nearest boundary point. The selected and weighted displacement vector is then used as the displacement vector 640 of point x_{q}_{ᵢ} 630. For a query domain λ_{q}, the geometric deformation φ can be represented by the set of displacement vectors of each point in the query domain. The geometric deformation φ containing these displacement vectors can be represented as a tensor of shape N_{q}×n.

It is understood that the specific method for determining the geometric deformation φ described above in conjunction with FIG. 6 is only an example, and any suitable method can be used to determine the deformation φ between the query domain and the reference domain. For example, a cutoff function may be applied to the displacement vector 640 described above to prevent points in the domain from displacing outside the geometric boundary. For example, in examples where the number of grid points in the query domain and the reference domain is the same, the geometric deformation φ between the two domains can be represented by a set of displacement vectors between corresponding points in the two domains, such as φ=λᵣ−λ_{q}, or φ=λ_{q}−λᵣ.

It will be understood that although the example of FIG. 6 shows one boundary 610 of the domain, there may be a plurality of boundaries in real-world applications, and the process for determining the displacement vector representing the geometric deformation φ is applicable to geometric domains containing a plurality of boundaries.

It will be understood that the query and reference domains shown in FIG. 6 correspond to the query shape and reference shape of the object, respectively, and the shape of the object may also be referred to as the geometric shape or geometric structure of the object equivalently. Thus, the terms “domain,” “shape,” and “geometry” are used interchangeably in the context of this specification.

As shown in FIG. 5A, the coordinates

$${\{ {x}_{{q}_{i}} \}}_{i = 1}^{{N}_{q}}$$

of the query domain φ can be transformed to the reference domain based on geometric deformation. Specifically, the coordinate point

$${\{ {x}_{{q}_{i}} \}}_{i = 1}^{{N}_{q}}$$

can be added to the displacement vector δx_{q} representing the geometric deformation φ to obtain the transformed coordinate point

$${\{ φ ( {x}_{{q}_{i}} ) \}}_{i = 1}^{{N}_{q}}$$

in the reference domain.

The preprocessing module 510 comprises a solution estimation module 5120, which determines the estimated value of the PDE solution at the transformed coordinate point

$${\{ φ ( {x}_{{q}_{i}} ) \}}_{i = 1}^{{N}_{q}}$$

based on the reference solution

$${u}_{r} = {\{ u ( {x}_{{r}_{i}} ) \}}_{i = 1}^{{N}_{r}}$$

at coordinate point

$${\{ {x}_{{r}_{i}} \}}_{i = 1}^{{N}_{r}}$$

and coordinate point

$${\{ {x}_{{r}_{i}} \}}_{i = 1}^{{N}_{r}}$$

representing the reference domain and the transformed coordinate point

$${\{ φ ( {x}_{{q}_{i}} ) \}}_{i = 1}^{{N}_{q}} .$$

The estimated value of the PDE solution at the converted coordinate point

$${\{ φ ( {x}_{{q}_{i}} ) \}}_{i = 1}^{{N}_{q}}$$

can be represented as uᵣ∘φ(x_{q}_{ᵢ}), which is a tensor of shape N_{q}×dₛ. Specifically, the reference solution

$${u}_{r} = {\{ u ( {x}_{{r}_{i}} ) \}}_{i = 1}^{{N}_{r}}$$

at the coordinate point

$${\{ {x}_{{r}_{i}} \}}_{i = 1}^{{N}_{r}}$$

is interpolated to the interpolated solution uᵣ∘φ(x_{q}_{ᵢ}) at the transformed coordinate point

$${\{ φ ( {x}_{{q}_{i}} ) \}}_{i = 1}^{{N}_{q}}$$

as an estimate of the solution at the transformed coordinate point. The solution estimation module 5120 may be referred to as the interpolation module, and it will be understood that any suitable interpolation method can be used to perform the interpolation.

The architecture of the RNO 520 can be represented as: [symbol] = [symbol] . [symbol] ∘ . . . ∘ [symbol] ∘ [symbol] , where [symbol] is the encoder, which promotes the input values to the latent space, [symbol] , l=1, . . . , L are the integral operator layers, and [symbol] : [symbol] → [symbol] is the decoder, which projects the latent variables back to the target space, where s is the dimension of the features in the latent space.

The RNO 520 comprises an encoder 5210, a plurality of integral operator layers 5220, and a decoder 5230. The encoder 5210 comprises a first sub-encoder 5211, a second sub-encoder 5212, and a third sub-encoder 5213. The first sub-encoder 5211 takes the interpolated solution uᵣ∘φ(x_{q}_{ᵢ}) as input and outputs a first feature sequence v₁∈ [symbol] . The first feature sequence which may also be referred to as a feature map. The second sub-encoder 5212 takes the geometric deformation φ=δx_{q} as input and outputs a second feature sequence v₂∈ [symbol] .

The third sub-encoder 5213 takes the transformed coordinate points φ(x_{q}_{ᵢ}) as input and outputs a third feature sequence v₃∈ [symbol] . It will be understood that the encoder 5210 can be implemented with any suitable neural network. For example, these sub-encoders can be implemented using a multilayer perceptron (MLP) neural network.

The integral operator layer 5220 comprises an integral kernel KN, which is used to process the first, second, and third feature sequences corresponding to the reference solution uᵣ, the geometric deformation φ, and the query structure data λ_{q}, respectively, and finally obtain the feature sequence z_{L}∈ [symbol] after integration. The decoder 5230 takes the feature sequence z_{L} as input and outputs the change in the solution δu, which is a tensor of shape N_{q}×dₛ. The predicted solution value u_{q}=uᵣ∘φ(x_{q})+δu can then be obtained. In another example, as shown by the dashed line at the output of the decoder 5230 in FIG. 5A, the decoder 5230 can directly output the predicted solution value u_{q}=u, which is a tensor of shape N_{q}×dₛ.

FIG. 5B shows an exemplary model architecture of an RNO according to one example. In FIGS. 5A and 5B, the same or corresponding designations are used to denote the same or corresponding units.

In the example shown in FIG. 5B, the third sub-encoder 5213 takes the coordinate points

$${\{ φ ( {x}_{{q}_{i}} ) \}}_{i = 1}^{{N}_{q}}$$

of the query domain as input and outputs the third feature sequence v₃∈ [symbol] ; while in the example shown in FIG. 5A, the third sub-encoder 5213 takes the transformed coordinate points φ(x_{q}_{ᵢ}) as input and outputs the third feature sequence v₃∈ [symbol] . The other operations of the RNO in the example shown in FIG. 5B are the same as those of the RNO in the example shown in FIG. 5A, and therefore will not be described again.

FIG. 5C shows an exemplary model architecture of an RNO according to one example. In FIGS. 5A to 5C, the same or corresponding designations are used to denote the same or corresponding units.

In the example shown in FIG. 5C, unlike the example shown in FIG. 5B, the solution estimation module 5120 determines the estimated value uᵣ∘x_{q}_{ᵢ} of the PDE solution at the coordinate point

$${\{ {x}_{{q}_{i}} \}}_{i = 1}^{{N}_{q}}$$

based on the coordinate point

$${\{ {x}_{{r}_{i}} \}}_{i = 1}^{{N}_{r}}$$

of the reference domain, the reference solution

$${u}_{r} = {\{ u ( {x}_{{r}_{i}} ) \}}_{i = 1}^{{N}_{r}}$$

at the coordinate point

$${\{ {x}_{{r}_{i}} \}}_{i = {1}^{′}}^{{N}_{r}}$$

and the coordinate point

$${\{ {x}_{{q}_{i}} \}}_{i = 1}^{{N}_{q}}$$

or the query domain.
Specifically, the reference solution

$${u}_{r} = {\{ u ( {x}_{{r}_{i}} ) \}}_{i = 1}^{{N}_{r}}$$

at the coordinate point

$${\{ {x}_{{r}_{i}} \}}_{i = 1}^{{N}_{r}}$$

is interpolated to the interpolated solution uᵣ∘x_{q}_{ᵢ} at the coordinate point

$${\{ {x}_{{q}_{i}} \}}_{i = 1}^{{N}_{q}}$$

as an estimate of the solution at the coordinate point

$${\{ {x}_{{q}_{i}} \}}_{i = 1}^{{N}_{q}} .$$

The other operations of the RNO in the example shown in FIG. 5C are the same as those of the RNO in the example shown in FIG. 5B, and therefore will not be described again.

FIG. 5D shows an exemplary model architecture of an RNO according to one example. In FIGS. 5A to 5D, the same or corresponding designations are used to denote the same or corresponding units.

In the example shown in FIG. 5D, the preprocessing module does not comprise the solution estimation module 5120, but instead directly uses the reference solution

$${u}_{r} = {\{ u ( {x}_{{r}_{i}} ) \}}_{i = 1}^{{N}_{r}}$$

as the input of the first sub-encoder 5211 to obtain the first feature sequence v₁∈ [symbol] , wherein the number of grid points Nᵣ in the reference domain and the number of grid points N_{q} in the query domain can be the same. Furthermore, the geometric deformation can be simplified as the difference between the coordinate point

$${\{ {x}_{{r}_{i}} \}}_{i = 1}^{{N}_{r}}$$

of the reference domain and the corresponding coordinate point

$${\{ {x}_{{q}_{i}} \}}_{i = 1}^{{N}_{q}}$$

of the query domain, which can be represented as φ=δx_{q}=λᵣ−λ_{q} or φ=δx_{q}=λ_{q}−λᵣ. The other operations of the RNO in the example shown in FIG. 5D are the same as those of the RNO in the example shown in FIG. 5C, and therefore will not be described again.

FIG. 5E shows an exemplary structure of an integral operator layer 5220 according to one example.

In this example, an attention-based network structure is used to implement the integral kernel KN. The attention-based network structure can also be called a Transformer-based network architecture. Although not shown in FIG. 5E, in one example, the third feature sequence v₃ is processed using the Q (query) matrix and the K (key) matrix to obtain the Q (query) feature sequence q and the K (key) feature sequence k, where the Q matrix and the K matrix are learnable parameters of the NN model.

The Q matrix and K matrix are s×s matrices, and the Q feature sequence q and K feature sequence k are N_{q}×s matrices. Thus, for a series of inputs

$$X = {\{ {x}_{i} \}}_{i = {1}^{′}}^{{N}_{q}}$$

the Q and K feature sequence q(X), k(X)∈ [symbol] and the M input value feature sequence v^{j}(X)∈ [symbol] , j=1, . . . , M are obtained. In this example, M=2, and the corresponding value feature sequence v^{j} is the first and second sequences, v₁ and v₂. As shown in FIG. 5E, attention can be obtained: attn(x, yᵢ)=softmax(q(x)k^{T} (yᵢ)), which can also be called the attention vector or attention matrix.

The distance weights help increase attention based on the spatial relationship between elements of the Q and K feature sequences q(X) and k(X). Considering that in some problems (e.g., fluid dynamics), the change of solution may be closely related to the location of deformation, distance weighting can be applied to the attention operation, so that the integral operator can be implemented as a distance-aware cross attention (DACA) layer, which can be expressed as Equation (8)

$$w ( x ) = {\sum }_{i = 1}^{N} {\sum }_{j = 1}^{M} {attn}_{j} ( x , {y}_{i} ) \cdot {h}_{r} ( d ( x , {y}_{i} ) ) \cdot {v}^{j} ( {y}_{i} ) \qquad ( 8 )$$

In this example, N=N_{q} and M=2, d(x, yᵢ) is a distance function, such as Euclidean distance, and

$$h ( d ) = e \frac{{d}^{2}}{{r}^{2}} ,$$

wherein r is a hyperparameter.

The attention attnⱼ for each value feature sequence vⱼ can have its own learnable Q matrix and K matrix, thus learning different kernel parameters for different value feature sequences vⱼ.

As shown in FIG. 5E, for the l-th integral operator layer or attention layer 5220-l, when l=1, i.e., the first integral operator layer, the input z₁ is the third feature sequence v₃; when l>1, the input z₁ is the output of the previous integral operator layer 5220-(l−1). The output of the integral operator layer 5220 is the output of the last integral operator layer 5220-L. The first and second feature sequences, v₁ and v₂, of the value feature sequence v^{j} are used as inputs to each integral operator layer or attention layer 5220-l. In this example, each integral operator layer [symbol] is constructed as:

$${z}_{l + 1} ( x ) = {ℒ}_{l} ( {z}_{l} ) ( x ) = {z}_{l} ( x ) + f ( {w}_{l} ( x ) ) \qquad ( 9 )$$

where w₁ is defined by Equation (8) and f is a composite function consisting of layer normalization and a multilayer perceptron (MLP) with a nonlinear activation function.

It will be understood that the attention-based integral operator layer shown in FIG. 5E is one implementation method. In specific applications, there can be various specific implementation methods for implementing the attention-based integral operator layer.

Looking back at the sensitivity learning in the training process shown in FIG. 3, for the Transformer structure, the nonlinearity of the attention unit complicates the calculation of the derivative, which is reflected in the following aspects: (i) the derivative of the Softmax function in the attention mechanism, set s=Softmax(z), z∈ [symbol] , then

$$\frac{\partial {s}_{i}}{\partial {z}_{i}} = {s}_{i} ( {δ}_{i j} - {s}_{j} ) ;$$

(ii) the chain rule and the product rule for the derivatives of Q, K, and V. Even for the linear Transformer model, the normalized derivative of linear attention is quite complex. These components of the Transformer structure introduce significant derivative biases into the structure of the neural operator, which is detrimental to the sensitivity learning of the neural operator.

On the other hand, the Fourier transform in the NN layer based on the Fourier transform is actually linear, so it does not introduce additional bias in terms of derivatives. However, the limitation of Fourier-based NN layers is that they can only handle a fixed number of uniform grid points, while many applications, especially structural optimization applications, need to handle irregular grids with a variable number of points.

The technical solution of the present disclosure proposes a virtual Fourier layer that transforms an irregular grid into a virtual physical space with a fixed number of detection points, so as to perform Fourier transform-based processing on the fixed number of detection points in the virtual physical space. By employing virtual Fourier layers, the neural operators are able to learn sensitivity better in the network structure, while also being able to handle irregular grids with variable numbers of points.

FIG. 5F shows an exemplary structure of an integral operator layer 5220 according to one example.

In this example, an integrator kernel KN is implemented using a network structure based on Fourier transform. For the l-th integral operator layer or Fourier layer 5220-l, when l=1, i.e., the first integral operator layer, the input z₁ is the feature sequence obtained based on the first to third feature sequences v₁, v₂, v₃, e.g.,

$${z}_{l} = {\sum }_{i = 1}^{3} {v}_{i} ;$$

when l>1, the input z₁ is the output of the previous integral operator layer 5220-(l−1). The output of the integral operator layer 5220 is the output 5220-L of the last integral operator layer 5220-L.

As shown in the figure, the integrator kernel KN-l comprises a first transformation layer P1, an integrator kernel FKN based on Fourier transform, and a second transformation layer P2. The first transformation layer P1 transforms the feature sequence z₁ containing N_{q} feature vectors corresponding to N_{q} grid points in the physical space to a virtual physical space with a fixed number of M detection points, resulting in a feature sequence zᵥ containing M feature vectors. The Fourier integrator kernel FKN processes the feature sequence zᵥ in the virtual physical space using a Fourier transform, resulting in an integrated feature sequence z′ᵥ containing M feature vectors. The second transformation layer P2 transforms the feature sequence z′ᵥ from the virtual physical space back into the physical space, obtaining an integrated feature sequence z′ᵥ corresponding to N_{q} grid points in the physical space, containing N_{q} feature vectors. In the integrated operator layer structure shown, the feature sequence is subjected to Fourier-based integration in the virtual physical space. Therefore, the integrated operator layer 5220-l can be called the virtual physical layer or the virtual Fourier layer. Since the number of grid points N_{q} in physical space is variable in different application examples, and the Fourier integral kernel FKN can only handle a fixed number of grid points, the NN model can handle various applications with a variable number of grid points by using a virtual Fourier layer as shown in the figure. At the same time, as noted above, by employing virtual Fourier layers, the neural operators are able to perform sensitivity learning better in terms of network structure.

In one example, the first transformation layer P1 performs a pointwise transformation on each feature vector in the feature sequence z₁. For example, for each feature vector zₗ∈ [symbol] , i=1, . . . , N_{q} in the input feature sequence zₗ∈ [symbol] , the first transformation layer P1 performs a point-by-point transformation projection on it to obtain Project (zₗ_{ᵢ})∈ [symbol] . This transformation projection can be achieved through any linear transformation, such as using an s×M projection matrix. Thus, N_{q} projection matrices can be used to linearly transform N_{q} feature vectors into N_{q} vectors Project (zₗ_{ᵢ})∈ [symbol] , i=1, . . . , N_{q}. The N_{q} projection matrices can be learnable parameters. Let

$${l}_{i} = \frac{Project ( {z}_{{l}_{i}} )}{\sqrt{s}} ∈ {ℝ}^{1 \times M} ,$$

then the distribution matrix l∈ [symbol] is obtained, where the element l_{i,j} represents the probability of linearly classifying the i-th point in the feature sequence z₁ to the j-th detection point in the virtual physical space, such as log odds.

Then, the first transformation layer P1 applies the normalized exponential function softmax( ) along the first dimension of the distribution matrix l to obtain the weight matrix ω⁽¹⁾∈ [symbol] Specifically, the elements

$${ω}_{i , j}^{( 1 )} = exp ( {l}_{i , j} ) / {\sum }_{i = 1}^{{N}_{q}} exp ( {l}_{i , j} ) , i = 1 , … , {N}_{q}$$

in the weight matrix ω⁽¹⁾. Then, based on the weight matrix ω⁽¹⁾, the N_{q} feature vectors in the feature sequence z₁ are weighted and aggregated to obtain the feature sequence zᵥ∈ [symbol] in the virtual physical space. For example, as shown in Equation (10), the feature vector zᵥ_{ⱼ}, j=1, . . . , M in the feature sequence zᵥ is obtained by weighted aggregation

$${z}_{{v}_{j}} = {\sum }_{i = 1}^{{N}_{q}} {ω}_{i , j}^{( 1 )} {z}_{{l}_{i}} , j = 1 , … , M \qquad ( 10 )$$

The feature sequence zᵥ∈ [symbol] can be intuitively understood as a one-dimensional signal sampled by M detection points in a virtual physical space, where each detection point has s dimensions or comprises s channels.

As shown in FIG. 5F, the Fourier integrator kernel FKN performs Fourier transform-based processing on the feature sequence zᵥ, where the feature sequence zᵥ comprises M feature vectors as M detection points in the virtual physical space. In one example, the Fourier integrator kernel FKN comprises a Fourier transform layer [symbol] , a linear transform layer R_{θ}, and an inverse Fourier transform layer [symbol] . The Fourier transform layer [symbol] performs a Fourier transform on the feature sequence zᵥ∈ [symbol] and truncates the high-frequency part to obtain the Fourier sequence [symbol] ∈ [symbol] , where k is the number of frequency modes of the Fourier transform. The linear transformation layer R_{θ} performs a linear transformation on the Fourier sequence [symbol] ∈ [symbol] to obtain the weighted Fourier sequence R_{θ}·( [symbol] )∈ [symbol] , where R_{θ}∈ [symbol] . For 1≤i≤k and 1≤j, l≤s,

$${( {R}_{θ} \cdot ( ℱ z ) )}_{l , j} = {\sum }_{l = 1}^{S} {{R}_{i , j , l} ( ℱ z )}_{i , l} .$$

The inverse Fourier transform layer [symbol] performs an inverse Fourier transform on the weighted Fourier sequence R_{θ}·( [symbol] ) to obtain the integral feature sequence z′= [symbol] (R_{θ}·( [symbol] ))∈ [symbol] in the virtual physical space. The above Fourier transform and inverse Fourier transform can be performed in any suitable manner, for example, by using Fast Fourier Transform (FFT) and Inverse Fast Fourier Transform (FFT⁻¹). Since the Fourier transform-based processing performed by the Fourier integrator kernel FKN is actually linear, its derivative does not add any additional bias to FKN. This is very beneficial for the learning of derivatives by neural operators.

The second transformation layer P2 transforms the feature sequence z′ᵥ from the virtual physical space back into the physical space, obtaining an integrated feature sequence z′ₗ∈ [symbol] corresponding to N_{q} grid points in the physical space, containing N_{q} feature vectors. According to one example, the weight matrix ω⁽²⁾∈ [symbol] is obtained by applying the normalized exponential function softmax( ) along the second dimension of the above distribution matrix l∈ [symbol] . Specifically, the elements

$${ω}^{( 2 )} = exp ( {l}_{i , j} ) / {\sum }_{j = 1}^{M} exp ( {l}_{i , j} ) , j = 1 , … , M$$

in the weight matrix ω⁽²⁾. Then, based on the weight matrix ω⁽²⁾, the M feature vectors in the feature sequence z′ᵥ are weighted and aggregated to obtain the feature sequence z′ₗ_{ᵢ}∈ [symbol] in the physical space. For example, as shown in Equation (11), the feature vector z′ₗ_{ᵢ}, i=1, . . . , N_{q} in the feature sequence z′ₗ is obtained by weighted aggregation

$${z}_{{l}_{i}}^{′} = {\sum }_{j = 1}^{M} {ω}_{i , j}^{( 2 )} {z}_{{v}_{j}}^{′} , i = 1 , … , {N}_{q} \qquad ( 11 )$$

As shown in the lower half of FIG. 5F, the weighted layer W of the integral operator layer 5220-l uses the weight matrix WE [symbol] to perform a linear transformation on the input feature sequence z′ₗ∈ [symbol] to obtain the weighted feature sequence W_{z}_{ₗ}∈ [symbol] . This is then added to the integral feature sequence z′ₗ∈ [symbol] and passed through the activation function σ to obtain the output feature sequence zₗ₊₁=σ(W_{z}_{ₗ}_{+z′}_{ₗ})∈ [symbol] of the integral operator layer 5220-l. The activation function σ is a non-linear activation function, such as a Gaussian error linear unit (GeLU).

It will be understood that the Fourier transform-based integral operator layer shown in FIG. 5F is one implementation of this example. In specific applications, it can be obviously modified to implement a Fourier transform-based integral operator layer.

The training of the NN model is illustrated below with reference to FIG. 3 with the RNOs shown in FIGS. 5A-5F as an example. The RNO essentially learns the relationship between the deformation of the geometric structure and the change in the PDE solution. Since similar changes in different geometric shapes will have similar effects on the PDE solution, the RNO can better generalize to predict the PDE solution of different objects with different shapes, and accordingly can learn more efficiently from the historical optimization trajectory of various structural optimization projects. Intuitively speaking, the RNO can learn to make high-quality predictions by referencing neighboring data within the same trajectory. In fact, the inherent correlation between data points along the same trajectory is important, and the RNO can capture changes in the solution based on subtle transformations in the input structure.

In order to train the RNO, it is necessary to provide a pair of data points for each query, which may be referred to as a reference-query data pair. According to one example, since the training data comes from the historical optimization trajectory of the structural optimization, each data point in the same trajectory can be paired with its nearest neighbor data points.

According to one example, the pairing process may be accomplished using a custom data loader that randomly selects a reference data point from the same trajectory for each data point. Specifically, for the data trajectory

$${\{ ( {λ}_{i} , {u}_{i} ) \}}_{i = 1}^{{N}_{s}} ,$$

Nₛ is the number of optimization steps in this trajectory, which is also the number of data points. For the i-th data, the data loader randomly assigns a reference data point j within the given index distance d, that is, selects the index j∈[l,r], where l=max(0, i−d) and r=min(Nₛ, i+d). The index j of the reference data in this example may be randomly set to i, which can modulate the predictive behavior of the RNO when the query data is near the reference data.

Moreover, since the reference data and query data are selected from the same structural optimization trajectory, they have the same grid structure. Even if there are deformed grids in shape optimization, there is a one-to-one correspondence between the reference data and query data. Therefore, the complexity of constructing deformations φ and interpolating between different meshes as described in the examples of FIGS. 5A to 5F can be reduced. This is an advantage of using structural optimization trajectories as a training dataset.

Table 1 below describes the training process in the form of pseudocode according to one example.

TABLE 1

Method 1: Train RNO
Input: RNO [symbol] , the data loader is used to load data pairs (λ_{q}, u_{q})
and (λᵣ, uᵣ), and the flag Sens is used to identify
sensitivity training,
for epoch = 0 to Nₑ − 1 do
u_{pred} = [symbol] (λ_{q}, uᵣ, φ)
Calculate loss L = L_{pred} = || u_{pred} − u_{q} ||
if Sens then
$Calculate objective function J and derivative \frac{\partial J}{\partial {λ}_{q}}$
Update loss L according to Equation (5)
end if
Update RNO [symbol] based on loss L
end for

In this example, Nₑ is the number of training rounds. The objective function value J can be calculated based on the structural optimization objective corresponding to the historical optimization trajectory, and the gradient

$$\frac{\partial J}{\partial {λ}_{q}}$$

can be calculated using gradient calculation tools.

Table 2 below describes the training process in the form of pseudocode according to one example.

TABLE 2

Method 1: Train RNO
Input: RNO [symbol] , the data loader is used to load data pairs (λ_{q}, u_{q})
and (λᵣ, uᵣ), the flag Sens is used to identify sensitivity
training, and the discard rate r_{drop} is used to discard reference
data points
for epoch = 0 to Nₑ − 1 do
Generate random number a~[0, 1]
If a < r_{drop} then
Discard λᵣ and φ
end if
u_{pred} = [symbol] (λ_{q}, uᵣ, φ)
Calculate loss L = L_{pred} = || u_{pred} − u_{q} ||
if Sens then
$Calculate objective function J and derivative \frac{\partial J}{\partial {λ}_{q}}$
Update loss L according to Equation (5)
end if
Update RNO [symbol] based on loss L
end for

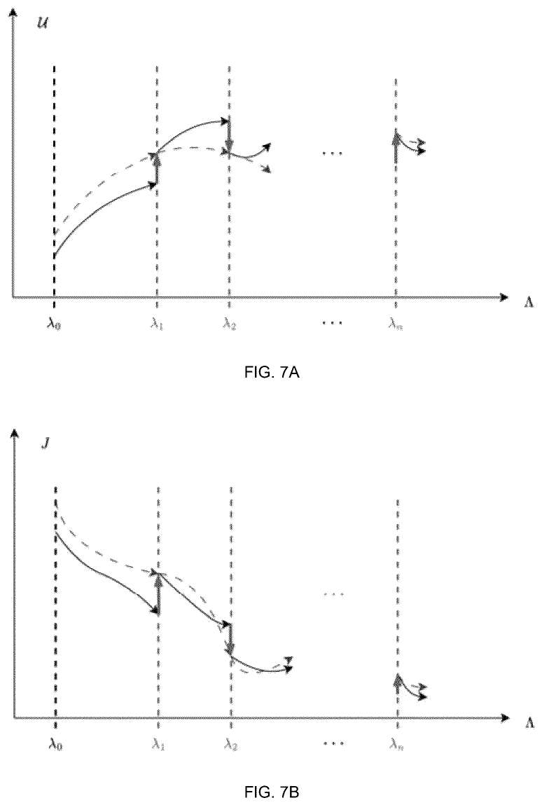

In this example, reference inputs λᵣ and φ are randomly discarded during training, causing the RNO to degenerate into an ordinary neural operator that maps from λ to u. For example, the discard rate r_{drop} can be set to 0.3 to balance training performance. Enabling this random discarding operation during training is beneficial, as it allows the RNO to perform inference flexibly without reference data. This is especially beneficial at the beginning of the optimization process, because the RNO can operate without relying on any truth solution. Therefore, unnecessary calculations by numerical solvers can be avoided in the initial stage of the structural design process. FIGS. 7A and 7B show schematic diagrams of a process for structural optimization of an object according to one example.

Since the RNO predicts query solutions based on reference solutions, it can recalibrate its predictions when new truth solutions are provided during the structural optimization process, thereby recalibrating the direction of structural optimization. Using the aforementioned characteristics of the RNO, according to one example, in the structural optimization process shown in FIG. 1, where the neural operator 170 is an RNO, when certain conditions are met, the numerical solver determines the PDE solution u_{q} as the calibration truth solution based on the current structural data λ_{q}. In the subsequent RNO prediction, the calibration truth solution is used as the reference solution, thereby continuously calibrating the RNO prediction to suppress the cumulative error. For example, the specific condition could comprise the difference between the most recently determined calibration truth solution by the numerical solver and the most recently determined predicted solution by the RNO being greater than a threshold. The difference between the calibration truth solution and the predicted solution can be the distance between the two, and can be any suitable distance that represents the difference between the two sets of data, such as the Euclidean distance. When this specific condition is met, it indicates that the reference value of the calibration truth value has decreased. Thus, the calibration truth value is generated again to recalibrate the calculation of the RNO. For another example, this specific condition may comprise a fixed number of rounds since the most recent start of the numerical solver, such that after a fixed number of structural optimization rounds, the numerical solver determines the calibrated truth solution.

FIGS. 7A and 7B show the same optimization trajectory. For clarity, the trajectory projected onto the [symbol] −Λ plane and the J−Λ plane are respectively shown on the two figures. The solid curve in FIG. 7A shows the trajectory of the RNO predicted solution u during the structural optimization process, and the dashed curve shows the trajectory of the truth solution u during the structural optimization process. The solid curve in FIG. 7B shows the trajectory of the optimization objective J obtained based on the RNO predicted solution u during the structural optimization process, and the dashed curve shows the trajectory of the optimization objective J obtained based on the truth solution u during the structural optimization process. As shown in FIG. 7A, starting from the input structure λ₀, the structure or shape λ of the object is iteratively optimized by using the RNO to predict the PDE solution u in the iterative structural optimization round. When the current shape is λ₁ in a certain round, the numerical solver is called to determine the calibration truth solution of the PDE because the trigger condition is met. As shown by the short arrow line on the dashed line where λ₁ is located, the prediction accuracy of the RNO is corrected in a timely manner by utilizing the characteristic of the RNO to predict the query solution based on the reference solution. At the same time, as shown in FIG. 7B, the accuracy of the optimization objective is corrected, effectively suppressing the cumulative error. As shown by the short arrow lines on the dashed lines of the x-coordinates λ₁, λ₂ . . . . Aₙ in FIGS. 7A and 7B, the numerical solver is invoked to perform the calibration process when the triggering condition is met.

According to one example, in a structural optimization round, noise εᵢ~ [symbol] (0,σ) can be added to the current structural data λ to obtain a plurality (N₁) of structural data instances

$${\{ ( λ + {ε}_{i} ) \}}_{i = 1}^{{N}_{1}} ,$$

where [symbol] (0,σ) represents a normal distribution with a mean of 0 and a standard deviation of σ, e.g., σ can be set to 5%. The RNO generates N₁ corresponding PDE solution instances

$${\{ u ( λ + {ε}_{i} ) \}}_{i = 1}^{{N}_{1}}$$

based on the N₁ structured data instances

$${\{ ( λ + {ε}_{i} ) \}}_{i = 1}^{{N}_{1}} .$$

based on the N₁ PDE solution instances

$${\{ u ( λ + {ε}_{i} ) \}}_{i = 1}^{{N}_{1}} ,$$

N₁ optimization objective value instances

$${\{ J ( u ( λ + {ε}_{i} ) , λ ) \}}_{i = 1}^{{N}_{1}}$$

are generated, and then N₁ gradient instances

$${\{ {\overline{V}}_{λ} J ( u ( λ + {ε}_{i} ) , λ ) \}}_{i = 1}^{{N}_{1}}$$

of the optimization objective with respect to the current structure are generated. Then, based on the N₁ gradient instances

$${\{ {\overline{V}}_{λ} J ( u ( λ + {ε}_{i} ) , λ ) \}}_{i = 1}^{{N}_{1}} ,$$

the gradient value of this round of structural optimization is obtained. For example, the final gradient value is obtained by averaging the N₁ gradient instances, as shown in Equation (12)

$$δ J = \frac{1}{{N}_{1}} {\sum }_{i = 1}^{{N}_{1}} {∇}_{λ} J ( u ( λ + {ε}_{i} ) , λ ) \qquad ( 12 )$$

In this example, the gradient value of the current round of structural optimization is obtained by adding noise to the current structural data, which makes the gradient smoother during the structural optimization process, thereby improving the performance of structural optimization.

According to one example, when the RNO processes an input structural data λ, a plurality of temporary solutions

$${\{ {𝒢}_{θ} ( λ , {u}_{{r}_{j}} , {φ}_{j} ) \}}_{j = 1}^{{N}_{2}}$$

can be determined based on a plurality (N₂) of reference data

$${\{ ( {u}_{{r}_{j}} , {λ}_{{r}_{j}} ) \}}_{j = 1}^{{N}_{2}} ,$$

where φⱼ is obtained based on the current structural data λ and the reference structure λᵣ_{ⱼ}. The predicted solution u is then obtained based on the N₂ temporary solutions

$${\{ {𝒢}_{θ} ( λ , {u}_{{r}_{j}} , {φ}_{j} ) \}}_{j = 1}^{{N}_{2}} .$$

For example, the final predicted solution u is obtained by averaging the N₂ temporary solutions, as shown in Equation (13)

$$u = \frac{1}{{N}_{2}} {\sum }_{j = 1}^{{N}_{2}} {𝒢}_{θ} ( λ , {u}_{{r}_{j}} , {φ}_{j} ) \qquad ( 13 )$$

In this example, the structural data λᵢ and the corresponding PDE solution uᵢ from the most recent optimization steps can be cached, and the cached data can be used as the aforementioned reference data

$${\{ ( {u}_{{r}_{j}} , {λ}_{{r}_{j}} ) \}}_{j = 1}^{{N}_{2}}$$

in the current optimization round. It will be understood that in some optimization rounds, the number of cached reference data points is less than N₂, and in this case, processing similar to Equation (13) is performed based on at least a portion of the cached reference data points

In this example, by predicting the PDE solution based on a plurality reference data points, the gradient can be made smoother during the structural optimization process, thereby improving the performance of structural optimization.

When using a combination of the examples shown in Equations (12) and (13), the maximum number of forward inferences of the RNO in a single structural optimization round is N₁N₂. Since the derivatives of the optimization objective J with respect to each structure instance (λ+εᵢ) are independent and can therefore be performed simultaneously, the RNO forward inference N₁N₂ does not substantially slow down the derivative calculation of Equation (12).

Table 3 below describes the structural optimization process of an object in the form of pseudocode according to one example.

TABLE 3
Method 3: Structural optimization using an RNO

Input: RNO [symbol] , initial structure λ₀, learning rate η > 0, cache list B with
size N₂, truth solution u_{gt} = None, number of structural optimization
rounds warm_up_steps before the first call to the numerical solver, radius
r as the trigger criterion
for i=1 to T − 1 do
If i > warm_up_steps and dist(uₜ, u_{gt}) > r then
Update u_{gt} using a numerical solver
Reset cache B = [u_{gt}]
end if
Calculate uₜ according to Equation (13) and δJ according to Equation (12)
Store uₜ in cache B
Update structureλₜ₊₁ ← λₜ − ηδJ
end for

In this example, dist(uₜ, u_{gt}) represents the distance between the most recent predicted solution and the most recent calibration truth solution. The operation of resetting cache B= [u_{gt}] will clear the historical values in cache B and store only u_{gt}, and in the following optimization steps, the predicted solutions predicted by the RNO will be stored in sequence. In one example, after cache B is full of N₂ solutions, the oldest value is replaced with the newest value in a first-in-first-out (FIFO) order. It will be understood that although not shown in Table 3, the structure A corresponding to the cached solution u also needs to be cached.

It will be understood that the examples shown in Table 3 provide a specific optimization process, and various obvious variations can be made to the process shown in different examples. For example, instead of using the operation methods shown in Equations (12) and (13), the PDE solution uₜ can be obtained by the RNO performing forward inference only once in a structural optimization step, and the optimization objective value J and its gradient δJ with respect to the structure can be calculated based on the PDE solution. For example, only the operation of Equation (12) or only the operation of Equation (13) may be employed. For example, when the judgment condition is met, the true solution u_{gt} obtained by the numerical solver can be directly used as the solution uₜ for this round, and the optimization objective value J and its gradient δJ with respect to the structure can be calculated based on the PDE solution. For another example, the parameter warm_up_steps and the corresponding judgment condition i>warm_up_steps may not be used in the optimization process. For another example, the order between the various steps in the processing process shown in Table 3 may be varied and may comprise more or fewer steps.

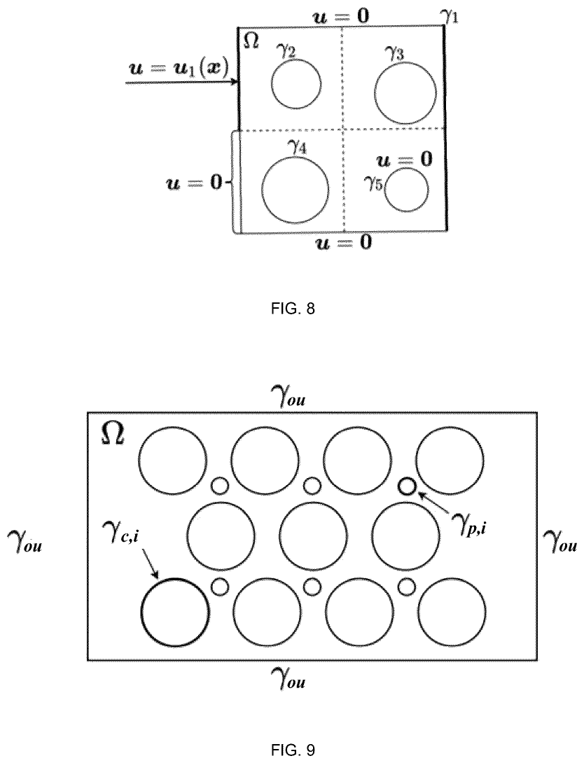

FIG. 8 shows an exemplary schematic diagram of objects and physical systems thereof according to one example.

The physical system shown in FIG. 8 corresponds to a guide plate, where the boundary γ₂ to γ₅ in the corresponding region is the guide plate. The constraint PDE used to describe the physical system associated with the guide plate may be:

$$Δ u ( x ) + {k}^{2} u ( x ) = f , x ∈ Ω \qquad ( 14 a )$$

$$u ( x ) = {u}_{1} ( x ) , x ∈ {γ}_{1 , left , up} \qquad ( 14 b )$$

$$u ( x ) = 0 , x ∈ {γ}_{wall} \qquad ( 14 c )$$

where x=(x₁, x₂) are spatial coordinates, u=(u₁, u₂) are velocities, k is a given constant, f=f(x) is a given function, γ_{1,left} is the left part of γ₁, γ_{1,left,up} is the upper part of γ_{1,left}, γ_{1,left,down} is the lower part of γ_{1,left}, γ_{wall}=γ_{1,up}∪γ_{1,down}∪γ₂∪γ₃∪γ₄∪γ₅∪γ_{1,left,down},

$${u}_{1} ( x ) = {[ \frac{( 4 - {x}_{2} ) ( 8 - {x}_{2} )}{16} , 0 ]}^{T}$$

According to one example, for the PDE of the physical system of the guide plate, the solution of the PDE can be predicted by the RNO according to various examples of the present disclosure (e.g., in conjunction with the NN model described in FIGS. 5A to 5F). According to one example, the RNO can be trained using training methods according to various examples of the present disclosure (e.g., in conjunction with the training method shown in FIG. 3).

According to one example, the goal of structural optimization of the baffles is to optimize the shape and position of the baffles γ₂ to γ₅ in order to obtain uniform fluid flow at the outlet γ_{1, right}, while minimizing the energy consumed by the fluid. The objective function of structural optimization may be constructed based on fluid mechanics, as shown in Equation (15):

$$J = \frac{1}{2} {\int }_{γ 1 , r ight} {\vert {u}_{1} - \overline{{u}_{1}} \vert}^{2} d s + β [ \frac{k}{2} {\int }_{Ω} {‖ ∇ {u}^{T} + ∇ u ‖}_{F}^{2} d x ] \qquad ( 15 )$$

where β is the balance factor, e.g. β=0.01, u=(u₁, u₂) is the velocity, and k is the viscosity. The goal of the structural optimization is to minimize the objective function J.

According to one example, the optimized design of the guide plate can be carried out using the structural optimization process described above in conjunction with FIGS. 7A and 7B. In the iterative structural optimization step, the RNO can be used to predict the corresponding physical data u based on the current structural data λ and the reference structure and reference physical data, and when needed, the numerical solver can be triggered to determine the corresponding physical data u based on the current structural data λ. The geometric parameters of an object may comprise the center coordinates and radi of the circles at boundaries γ₂ to γ₅. After mesh discretization of the geometric structure domain Ω formed by the boundaries γ₁ to γ₅, the discretized structural data λ can be obtained, for example, λ={(x₁, x₂, m₁)}^{N}, where N is the number of discretized grid points, x₁ and x₂ are spatial coordinates, and m₁∈{0,1} is a mask used to identify whether the point (x₁, x₂) belongs to the internal boundary, that is, γ₂∪γ₃∪γ₄∪γ₅.

FIG. 9 shows an exemplary schematic diagram of objects and physical systems thereof according to one example.

The physical system shown in FIG. 9 corresponds to a two-dimensional battery pack. The constraint PDE used to describe the physical system associated with the two-dimensional battery pack may be:

$$\frac{\partial T}{\partial t} = k Δ T ( x , t ) , x ∈ Ω , t ∈ ( 0 , 1 ] , \qquad ( 16 a )$$

$$k ( n ( x ) \cdot ∇ T ( x , t ) ) = h ( {T}_{a} - T ( x , t ) ) , x ∈ {γ}_{o u} , t ∈ ( 0 , 1 ] , \qquad ( 16 b )$$

$$k ( n ( x ) \cdot ∇ T ( x , t ) ) = h ( {T}_{c} - T ( x , t ) ) , x ∈ {γ}_{c , i} , t ∈ ( 0 , 1 ] , i = 1 , … , {n}_{c} , \qquad ( 16 c )$$

$$k ( n ( x ) \cdot ∇ T ( x , t ) ) = h ( {T}_{w} - T ( x , t ) ) , x ∈ {γ}_{p , i} , t ∈ ( 0 , 1 ] , i = 1 , … , {n}_{w} , \qquad ( 16 d )$$

$$T ( x , 0 ) = {T}_{0} , x ∈ Ω , \qquad ( 16 e )$$

where x=(x₁, x₂) are spatial coordinates, t is the time coordinate, T(x, t) is the temperature that changes with time, k is the thermal conductivity,

$$Δ T = {\partial }^{2} T \partial {x}_{1}^{2} + {\partial }^{2} T / \partial {x}_{2}^{2} ,$$

and h is the heat transfer coefficient. ∇T=(∂T/∂x₁, ∂T/∂x₂), Tₐ, T_{c}, T_{w} are the temperatures of the air, the battery cells (n_{c}=11 battery cells with radius r_{c}), and the cooling pipes (n_{w}=6 pipes with radius r_{w}), respectively, and are set to Tₐ=0.1, T_{c}=5, and T_{w}=1. T₀ is the initial temperature, which is set to T₀=0.1 in this example. In FIG. 9, γₒᵤ represents the outer boundary of the battery pack, γ_{c,i} represents the boundary of the battery cell, and γ_{p,i} represents the boundary of the cooling pipe. Temperature T(x, t) is an unknown physical quantity that needs to be solved based on these PDEs.

According to one example, for a time-dependent PDE of the physical system of a two-dimensional battery pack, by taking time t as an additional spatial dimension, the solution of the PDE can be predicted by the RNO according to various examples of the present disclosure (e.g., in conjunction with the NN model described in FIGS. 5A to 5F). According to one example, the RNO can be trained using training methods according to various examples of the present disclosure (e.g., in conjunction with the training method shown in FIG. 3).

According to one example, the battery cell boundaries and cooling pipe boundaries located within region Ω are structures that need to be optimized. The goal of the structural optimization of the battery pack is to optimize the shape and position of battery cells and cooling pipes in order to obtain a uniform temperature distribution that changes over time. The structural optimization objective of a two-dimensional battery pack can be expressed as Equation (17):

$$J = {\int }_{t} {\int }_{Ω} \vert T ( x ) - {T}_{ref} ( x ) \vert dx dt \qquad ( 17 )$$

where T is the temperature and T_{ref} is the reference temperature. The goal of the structural optimization is to minimize the objective function J.

According to one example, the optimized design of the two-dimensional battery pack can be carried out using the structural optimization process described above in conjunction with FIGS. 7A and 7B. In the iterative structural optimization step, the RNO can be used to predict the corresponding physical data u based on the current structural data λ and the reference structure and reference physical data, and when needed, the numerical solver can be triggered to determine the corresponding physical data u based on the current structural data λ. The geometric parameters of an object may comprise the center coordinates and radii of the circles at boundaries γ_{c,i} and γ_{p,i}. After mesh discretization of the geometric structure domain Ω, which is composed of the outer boundary You and the inner boundaries γ_{c,i} and γ_{p,i}, the discretized structural data λ can be obtained, for example, λ={(x₁, x₂, m₁, m₂)}^{N}, where N is the number of discretized grid points, x₁, x₂ are spatial coordinates, and m₁, m₂∈{0, 1} are masks used to identify whether the point (x₁, x₂) belongs to the inner boundaries γ_{c,i} and γ_{p,i}.

It will be understood that although the PDE solution prediction, RNO training, and structural optimization processes of examples of the present disclosure are illustrated using specific objects such as guide plates and two-dimensional battery packs as examples, these methods can also be applied to other objects. For example, the object may be one of several objects to be manufactured or designed, such as a fuel cell bipolar plate, a component of a vehicle, a component of an aircraft, a component of a building, a pipeline of a reactor, a flow guide plate, etc. For example, structural data related to the structure of an object may comprise at least some of position, radius, width, height, length, anchor points, etc., while physical data related to the physical state of an object may comprise at least some of velocity, pressure, temperature, electric field, magnetic field, etc.

FIG. 10 shows a method for determining the physical state of an object having a shape according to one example.

In step 1010, first structural data representing the first shape of the object is received.

In step 1020, a first feature sequence comprising N feature vectors is generated based on the first structural data. The first feature sequence is, e.g., the feature sequence z₁ in the physical space described in FIG. 5F.

In step 1030, the first feature sequence is converted into a second feature sequence comprising M feature vectors. The second feature sequence is, e.g., the feature sequence zᵥ in the virtual physical space described in FIG. 5F.

In step 1040, the second feature sequence is processed based on Fourier transform to obtain a third feature sequence comprising M feature vectors. The third feature sequence is, e.g., the feature sequence z′ᵥ in the virtual physical space described in FIG. 5F.

In step 1050, the third feature sequence is converted into a fourth feature sequence comprising N feature vectors. The fourth feature sequence is, e.g., the feature sequence z′ₗ in the physical space described in FIG. 5F.

In step 1060, first physical state data representing the physical state of an object having the first shape is determined based on the fourth feature sequence. As illustrated in the example described in conjunction with FIGS. 5A to 5D, in one example, when determining the first physical state data of an object, the decoder 5230 can directly output the first physical state data. In another example, the decoder 5230 may output the amount of change of physical state data relative to reference physical state data, and then obtain first physical state data based on the amount of change and the reference physical state data. It will be understood that the method 1000 does not necessarily have to be implemented using an RNO network architecture, but can also be implemented using a non-RNO network architecture that includes a virtual Fourier layer illustrated in FIG. 5F.

According to one example, in step 1010, reference structural data representing a reference shape of an object and reference physical data representing the physical state of an object having the reference shape are also received. In step 1020, the first feature sequence is generated based on the first structural data, the reference structural data, and the reference physical data.

According to one example, in step 1020, a fifth feature sequence comprising N feature vectors is generated based on the first structural data; a sixth feature sequence comprising N feature vectors is generated based on the first structural data and the reference structural data; a seventh feature sequence comprising N feature vectors is generated based on the reference physical data; and the first feature sequence is generated based on the fifth feature sequence, the sixth feature sequence, and the seventh feature sequence. The fifth feature sequence is, e.g., a feature sequence related to the query structure, such as the feature sequence v₃ in the example of FIGS. 5A to 5D. The sixth feature sequence is, e.g., a feature sequence related to deformation, such as the feature sequence v₂ in the example of FIGS. 5A to 5D. The seventh feature sequence is, e.g., a feature sequence related to the reference solution, such as the feature sequence v₁ in the example of FIGS. 5A to 5D. According to one example, in step 1030, a first weight matrix is obtained based on the first feature sequence; and the N feature vectors in the first feature sequence are weighted and aggregated based on the first weight matrix to obtain the second feature sequence comprising M feature vectors. The first weight matrix is, e.g., the weight matrix ω⁽¹⁾ described in conjunction with the example in FIG. 5F. For example, the second feature sequence comprising M feature vectors is obtained by weighting and aggregating the N feature vectors in the first feature sequence based on the M column vectors in the first weight matrix.

According to one example, in step 1050, a second weight matrix is obtained based on the first feature sequence; and the M feature vectors in the third feature sequence are weighted and aggregated based on the second weight matrix to obtain the fourth feature sequence comprising N feature vectors. The second weight matrix is, e.g., the weight matrix ω⁽²⁾ described in conjunction with the example in FIG. 5F. For example, the fourth feature sequence comprising N feature vectors is obtained by weighting and aggregating the M feature vectors in the third feature sequence based on the N row vectors in the second weight matrix.

According to one example, in step 1030, obtaining the first weight matrix based on the first feature sequence comprises: transforming the N feature vectors in the first feature sequence into N distribution vectors, each of which comprises M distribution elements and constitutes a distribution matrix; and obtaining the first weight matrix based on the distribution matrix. The distribution matrix is, e.g., the distribution matrix 1 illustrated in the example of FIG. 5F, wherein for each of the N feature vectors in the first feature sequence, the M distribution elements in the corresponding distribution vector represent the probability of distributing the point in the physical space corresponding to the feature vector to the corresponding M detection points in the virtual physical space. According to one example, in step 1050, obtaining the second weight matrix based on the first feature sequence comprises: obtaining the second weight matrix based on the distribution matrix.

According to one example, in step 1030, obtaining the first weight matrix based on the distribution matrix comprises: for each distribution element in the distribution matrix, determining the weight element in the first weight matrix corresponding to the distribution element based on each element in the column where the element is located. According to one example, in step 1050, obtaining the second weight matrix based on the distribution matrix comprises: for each distribution element in the distribution matrix, determining the weight element in the second weight matrix corresponding to the distribution element based on each element in the row where the element is located.

According to one example, the object is at least one of a fuel cell bipolar plate, a part of a car, a part of an airplane, a part of a building, a pipe of a reactor, and a guide plate, and the physical data comprises at least one of velocity, pressure, temperature, electric field, and magnetic field.

FIG. 11 shows a method for structural optimization of an object according to one example.

The method 1100 comprises steps 1110 to 1130 that are iteratively performed.

In step 1110, first structural data representing the first shape of the object is received. The first structural data is the current structural data output by step 1130 in the previous optimization step or optimization round.

In step 1120, first physical state data representing the physical state of the object having the first shape is determined based on the first structural data. In this step, the methods provided in the various examples of the present disclosure can be used to determine the first physical state data.

In step 1130, the first structural data is updated based on the first physical state data to obtain updated first structural data representing an updated first shape of the object. The updated first structural data is provided to step 1110. According to one example, in step 1130, a first gradient of the optimization objective of the structural optimization with respect to the first structural data is determined based on the first physical data; and the updated first structural data is obtained based on the first structural data and the first gradient.

According to one example, in step 1120, when a first condition is met, a numerical solver determines first calibration physical data representing the physical state of the object having the first shape based on the first structural data, wherein the first calibration physical data is used as the first physical data representing the physical state of the object having the first shape, or the first calibration physical data is used as reference physical data to predict the first physical data representing the physical state of the object having the first shape using an NN model; when the first condition is not met, the first physical state data representing the physical state of the object having the first shape is determined using an NN model.

According to one example, the first condition comprises: the difference (e.g., distance) between the first calibration physical data determined by the numerical solver in the most recent time the first condition was met and the first physical data determined by the NN model most recently is greater than a first threshold.

FIG. 12 shows a method for training an NN model for determining the physical state of an object having a shape according to one example. The NN model comprises a virtual Fourier layer, the virtual Fourier layer comprising a first transformation layer, a Fourier processing layer, and a second transformation layer.

In step 1210, first structural data representing a first shape of a first object and first labeled physical state data representing the physical state of the first object having the first shape are received.

In step 1220, a first feature sequence comprising N feature vectors is generated based on the first structural data. In step 1230, the first feature sequence is converted into a second feature sequence comprising M feature vectors through the first transformation layer.

In step 1240, the second feature sequence is processed by the Fourier processing layer based on Fourier transform to obtain a third feature sequence comprising M feature vectors.

In step 1250, the third feature sequence is converted into a fourth feature sequence comprising N feature vectors through the second transformation layer.

In step 1260, first predicted physical state data representing the physical state of the first object having the first shape is determined based on the fourth feature sequence.

In step 1270, the learnable parameters of the neural network model are updated based on the first predicted physical state data and the first labeled physical state data.

According to one example, in step 1210, reference structural data representing a reference shape of the first object and reference physical data representing the physical state of the object having the reference shape are also received. In step 1220, the first feature sequence is generated based on the first structural data, the reference structural data, and the reference physical data.

According to one example, the neural network model further comprises an encoder and a decoder. In step 1220, a fifth feature sequence comprising N feature vectors is generated by the encoder based on the first structural data; a sixth feature sequence comprising N feature vectors is generated by the encoder based on the first structural data and the reference structural data; a seventh feature sequence comprising N feature vectors is generated by the encoder based on the reference physical data; and the first feature sequence is generated based on the fifth feature sequence, the sixth feature sequence, and the seventh feature sequence.

According to one example, in step 1230, a first weight matrix is obtained based on the first feature sequence; and the N feature vectors in the first feature sequence are weighted and aggregated based on the first weight matrix to obtain the second feature sequence comprising M feature vectors. According to one example, in step 1250, a second weight matrix is obtained based on the first feature sequence; and the M feature vectors in the third feature sequence are weighted and aggregated based on the second weight matrix to obtain the fourth feature sequence comprising N feature vectors.

According to one example, in step 1230, obtaining the first weight matrix based on the first feature sequence comprises: transforming the N feature vectors in the first feature sequence into N distribution vectors, each of which comprises M distribution elements and constitutes a distribution matrix; and obtaining the first weight matrix based on the distribution matrix. According to one example, in step 1250, obtaining the second weight matrix based on the first feature sequence comprises: obtaining the second weight matrix based on the distribution matrix.

According to one example, in step 1230, obtaining the first weight matrix based on the distribution matrix comprises: for each distribution element in the distribution matrix, determining the weight element in the first weight matrix corresponding to the distribution element based on each element in the column where the element is located. According to one example, in step 1250, obtaining the second weight matrix based on the distribution matrix comprises: for each distribution element in the distribution matrix, determining the weight element in the second weight matrix corresponding to the distribution element based on each element in the row where the element is located.

According to one example, the method 1200 further comprises: receiving a first labeled gradient of the optimization objective for the structural optimization of the first object with respect to the first structural data corresponding to the first structural data and the first labeled physical state data; and determining the first gradient of the optimization objective for the structural optimization with respect to the first structural data based on the first predicted physical state data. In step 1270, the learnable parameters of the neural network model are updated based on the first predicted physical state data, the first labeled physical state data, the first gradient, and the first labeled gradient. According to one example, in step 1270, a first loss is determined based on the first predicted physical state data and the first labeled physical state data; a second loss is determined based on the first gradient and the first labeled gradient; and the learnable parameters of the neural network model are updated based on the first loss and the second loss.

According to one example, the first structural data, the first labeled physical state data, and the first labeled gradient are derived from historical optimization trajectory data used to optimize the structure of the first object.

According to one example, the method 1200 further comprises: generating a random value. In step 1220, the generation of the first feature sequence based on the first structural data, the reference structural data, and the reference physical data comprises: when the comparison between the random value and a reference discard threshold meets a second condition, generating the first feature sequence based on the first structural data, the reference structural data, and the reference physical data; when the comparison between the random value and the reference discard threshold does not meet the second condition, generating the first feature sequence based only on the first structural data.

According to one example, the method 1200 further comprises: receiving second structural data representing a second shape of a second object and second labeled physical state data representing a physical state of the second object having the second shape; generating a first feature sequence comprising K feature vectors based on the second structural data of the second object; converting the first feature sequence comprising K feature vectors into a second feature sequence comprising M feature vectors through the first transformation layer; performing Fourier transform-based processing on the second feature sequence through the Fourier processing layer to obtain a third feature sequence comprising M feature vectors; converting the third feature sequence into a fourth feature sequence comprising K feature vectors through the second transformation layer; determining second predicted physical state data representing a physical state of the second object having the second shape based on the fourth feature sequence comprising K feature vectors; and updating the learnable parameters of the neural network model based on the second predicted physical state data and the second labeled physical state data. In this example, the second object is a different object from the first object. For example, the first object and the second object are the guide plate and the two-dimensional battery pack shown in FIGS. 8 and 9, respectively. By introducing a virtual Fourier layer into the NN model, the NN model can enhance its gradient learning ability while processing structural data of different objects. Furthermore, NN models utilizing the RNO framework can learn the intrinsic relationship between shape changes and solution transformations, thereby enabling more effective learning of the relationship between structural changes of different objects and PDE solutions. Therefore, by utilizing the above virtual Fourier layer and/or RNO framework, the NN model can effectively learn the prediction of PDE solutions and the gradient of the structural optimization objective with respect to the structure from the historical optimization trajectories of various structural optimization projects for different objects.

According to one example, the method 1200 further comprises: receiving a second labeled gradient of the optimization objective for structural optimization of the second object corresponding to the second structural data and the second labeled physical state data with respect to the second structural data; and determining a second gradient of the optimization objective for structural optimization with respect to the second structural data based on the second predicted physical state data; wherein the updating of the learnable parameters of the neural network model based on the second predicted physical state data and the second labeled physical state data comprise: updating the learnable parameters of the neural network model based on the second predicted physical state data, the second labeled physical state data, the second gradient, and the second labeled gradient.

FIG. 13 shows a method for structural optimization of an object according to one example.

The method 1300 comprises the following steps 1310 to 1350 that are iteratively performed.

In step 1310, first structural data representing the first shape of the object is received.

In step 1320, a judgment is made as to whether a first condition is met.

In step 1330, when the first condition is met, the numerical solver determines first calibration physical data representing the physical state of an object having the first shape based on the first structural data, wherein the first calibration physical data is used as first physical data representing the physical state of an object having the first shape, or the first calibration physical data is used as reference physical data for a first NN model to predict the first physical data representing the physical state of an object having the first shape. As indicated by arrows 1330 to 1350, when the first condition is met, the first calibration physical data is used as first physical data representing the physical state of an object having the first shape and provided to step 1350; or, as indicated by dashed arrows 1330 to 1340, when the first condition is met, the first calibration physical data is provided to step 1340 so that the first NN model can use it as reference physical data to predict the first physical data of the physical state of an object having the first shape, and the predicted first physical data is provided to step 1350.

In step 1340, when the first condition is not met, the first NN model determines the first physical data representing the physical state of the object having the first shape based on the first structural data, the reference structural data representing the reference shape of the object, and the reference physical data representing the physical state of the object having the reference shape.

In step 1350, the first structural data of the object is updated based on the first physical data to obtain updated first structural data representing an updated first shape of the object. The updated first structural data is provided to step 1310 to cycle the method 1300 in the next structural optimization step.

According to one example, the first condition comprises: the difference between the first calibration physical data determined by the numerical solver in the most recent time the first condition was met and the first physical data determined by the first NN model most recently is greater than a first threshold. This gap is, e.g., the distance between the first calibration physical data and the first physical data, such as dist(uₜ, u_{gt}) as illustrated in Table 3 above. It will be understood that the first condition may only comprise the difference being greater than the first threshold, or it may additionally comprise other conditions.

According to one example, the reference structural data and the reference physical data respectively comprise the first structural data processed by the numerical solver when the first condition was most recently met and the first calibration physical data determined accordingly. For example, as illustrated in Table 3 above, the first calibration physical data

u_{gt} determined by the numerical solver when the first condition was most recently met can be stored in cache B, e.g., B=[u_{gt}].

According to one example, the reference structural data and the reference physical data respectively comprise one or more of the first structural data processed by the first NN model in one or more iteration rounds after the first condition was most recently met and one or more of the first physical data determined accordingly. For example, as illustrated in Table 3 above, the first physical data uₜ is obtained by the RNO in an iterative round and stored in cache B, which can comprise at most the previous N2 solutions.

According to one example, the reference structural data and the reference physical data respectively comprise a plurality of the first structural data processed in a plurality of iteration rounds and a plurality of first physical data determined accordingly. In step 1340, the first NN model determines a plurality of first temporary physical data representing the physical state of the object having the first shape based on the first structural data, each of the plurality of the first structural data, and each of the plurality of the first physical data determined accordingly; and determines the first physical data based on the plurality of first temporary physical data. For example, the plurality of first temporary physical data is averaged to obtain the first physical data.

According to one example, in step 1350, a first gradient of the optimization objective of the structural optimization with respect to the first structural data is determined based on the first physical data; and the updated first structural data is obtained based on the first structural data and the first gradient.

According to one example, in step 1340, noise is added to the first structural data to obtain a plurality of first structural data instances of the first structural data; the first NN model determines a plurality of first physical data instances representing the physical state of the object having the first shape based on each of the plurality of first structural data instances, the reference structural data, and the reference physical data to serve as the first physical data. In step 1350, based on each of the plurality of first physical data instances, a plurality of first gradient instances of the optimization objective of the structural optimization with respect to the first structural data are determined; and the first gradient is determined based on the plurality of first gradient instances. For example, the plurality of first gradient instances are averaged to obtain the first gradient.

According to one example, the reference structural data and the reference physical data respectively comprise a plurality of the first structural data processed in a plurality of iteration rounds and a plurality of first physical data determined accordingly. For example, as illustrated in Table 3 above, a plurality of PDE solutions uₜ and a plurality of corresponding structural data λₜ are stored in cache B in the most recent plurality of iteration rounds. In this example, the plurality of PDE solutions uₜ in cache B contain at most N2 solutions, and may or may not comprise the calibration solution u_{gt}. For example, when the number of rounds since the last time the first condition was met exceeds N₂, cache B comprises the solution uₜ from the last N₂ rounds, but no longer comprises the calibration solution u_{gt}. In step 1340, determining a plurality of first physical data instances representing the physical state of the object having the first shape comprises: for each of the plurality of first structural data instances: the first NN model determines a plurality of first temporary physical data representing the physical state of the object having the first shape based on the first structural data instances, each of the plurality of the first structural data, and each of the plurality of the first physical data determined accordingly; and determines a first physical data instance corresponding to the first structural data instance based on the plurality of first temporary physical data to serve as one of the plurality of first physical data instances.

According to one example, the NN model comprises a virtual Fourier layer, the virtual Fourier layer comprising a first transformation layer, a Fourier processing layer, and a second transformation layer. The first transformation layer converts a first feature sequence comprising N feature vectors into a second feature sequence comprising M feature vectors, wherein the first feature sequence is obtained based on the first structural data, the reference structural data, and the reference physical data, and wherein N is not equal to M. N is the number of points representing the structure of an object in the physical space and M is the number of detectors in the virtual physical space. N is variable and M is fixed. The second feature sequence is processed by the Fourier processing layer based on Fourier transform to obtain a third feature sequence comprising M feature vectors. The third feature sequence is converted into a fourth feature sequence comprising N feature vectors through the second transformation layer.

According to one example, the conversion of a first feature sequence comprising N feature vectors into a second feature sequence comprising M feature vectors by the first transformation layer comprises: obtaining a first weight matrix based on the first feature sequence; and weighting and aggregating the N feature vectors in the first feature sequence based on the first weight matrix to obtain the second feature sequence comprising M feature vectors. For example, the second feature sequence comprising M feature vectors is obtained by weighting and aggregating the N feature vectors in the first feature sequence based on the M column vectors in the first weight matrix. According to one example, the conversion of the third feature sequence into a fourth feature sequence comprising N feature vectors through the second transformation layer comprises: obtaining a second weight matrix based on the first feature sequence; and weighting and aggregating the M feature vectors in the third feature sequence based on the second weight matrix to obtain the fourth feature sequence comprising N feature vectors. For example, the fourth feature sequence comprising N feature vectors is obtained by weighting and aggregating the M feature vectors in the third feature sequence based on the N row vectors in the second weight matrix.

According to one example, obtaining the first weight matrix based on the first feature sequence comprises: transforming the N feature vectors in the first feature sequence into N distribution vectors, each of which comprises M distribution elements and constitutes a distribution matrix; and obtaining the first weight matrix based on the distribution matrix. Obtaining the second weight matrix based on the first feature sequence comprises: obtaining the second weight matrix based on the distribution matrix.

According to one example, obtaining the first weight matrix based on the distribution matrix comprises: for each distribution element in the distribution matrix, determining the weight element in the first weight matrix corresponding to the distribution element based on each element in the column where the element is located. Obtaining the second weight matrix based on the distribution matrix comprises: for each distribution element in the distribution matrix, determining the weight element in the second weight matrix corresponding to the distribution element based on each element in the row where the element is located.

According to one example, the first NN model further comprises an encoder and a decoder. The encoder generates a fifth feature sequence, a sixth feature sequence, and a seventh feature sequence, each comprising N feature vectors, based on the first structural data, the reference structural data, and the reference physical data. The first feature sequence is generated based on the fifth feature sequence, the sixth feature sequence, and the seventh feature sequence. The decoder predicts the first physical data or the amount of physical data change used to determine the first physical data based on the fourth feature sequence.

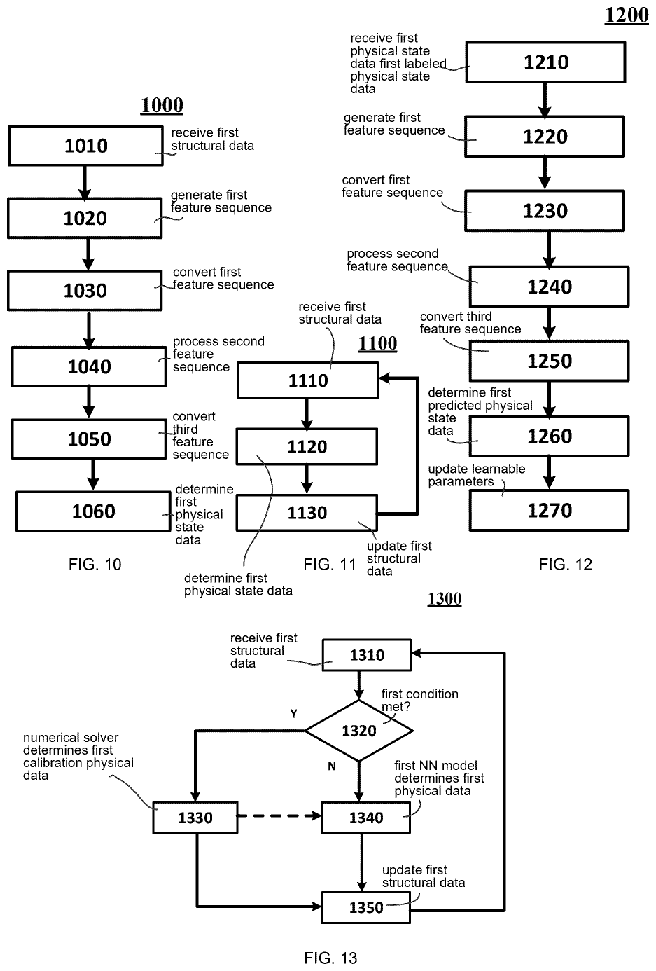

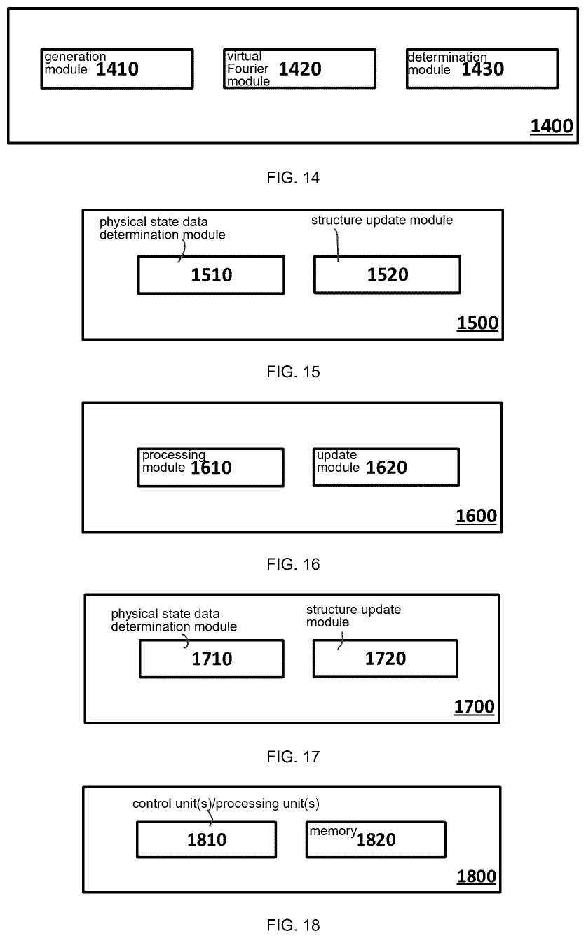

FIG. 14 shows an apparatus for determining the physical state of an object having a shape according to one example.

The apparatus 1400 comprises: a generation module 1410 for generating a first feature sequence comprising N feature vectors based on first structural data representing a first shape of the object; a virtual Fourier module 1420 for converting the first feature sequence into a second feature sequence comprising M feature vectors, performing Fourier transform-based processing on the second feature sequence to obtain a third feature sequence comprising M feature vectors, and converting the third feature sequence into a fourth feature sequence comprising N feature vectors; and a determination module 1330 for determining first physical state data representing the physical state of the object having the first shape based on the fourth feature sequence.

According to one example, the generation module 1410 generates the first feature sequence based on the first structural data, reference structural data representing the reference shape of the object, and reference physical data representing the physical state of the object having the reference shape.

According to one example, the generation module 1410 generates a fifth feature sequence comprising N feature vectors based on the first structural data; generates a sixth feature sequence comprising N feature vectors based on the first structural data and the reference structural data; generates a seventh feature sequence comprising N feature vectors based on the reference physical data; and generates the first feature sequence based on the fifth feature sequence, the sixth feature sequence, and the seventh feature sequence.

According to one example, the virtual Fourier module 1420 obtains a first weight matrix based on the first feature sequence; and weights and aggregates the N feature vectors in the first feature sequence based on the first weight matrix to obtain the second feature sequence comprising M feature vectors.

According to one example, the virtual Fourier module 1420 obtains a second weight matrix based on the first feature sequence; and weights and aggregates the M feature vectors in the third feature sequence based on the second weight matrix to obtain the fourth feature sequence comprising N feature vectors.

According to one example, the virtual Fourier module 1420 transforms the N feature vectors in the first feature sequence into N distribution vectors, each of which comprises M distribution elements and constitutes a distribution matrix; and obtains the first weight matrix and the second weight matrix based on the distribution matrix.

According to one example, the virtual Fourier module 1420, for each distribution element in the distribution matrix, determines the weight element in the first weight matrix corresponding to the distribution element based on each element in the column where the element is located. According to one example, the virtual Fourier module 1420, for each distribution element in the distribution matrix, determines the weight element in the second weight matrix corresponding to the distribution element based on each element in the row where the element is located.

FIG. 15 shows an apparatus for structural optimization of an object according to one example.

The apparatus 1500 comprises: a physical state data determination module 1510 for determining first physical state data representing a physical state of the object having a first shape based on first structural data representing a first shape of the object; and a structure update module 1520 for updating the first structural data based on the first physical state data to obtain updated first structural data representing an updated first shape of the object.

The physical state data determination module 1510 may determine the first physical state data using the methods provided in various examples of the present disclosure. The physical state data determination module 1510 and the structure update module 1520 may operate iteratively to optimize the structure of the object. The first structural data that the physical state data determination module 1510 is based on in an optimization step or optimization round is the current structural data output by the structure update module 1520 in the previous optimization step or optimization round.

According to one example, the structure update module 1520 determines a first gradient of the optimization objective of the structural optimization with respect to the first structural data based on the first physical data; and obtains the updated first structural data based on the first structural data and the first gradient.

According to one example, when a first condition is met, the physical state data determination module 1510 determines first calibration physical data representing the physical state of the object having the first shape based on the first structural data using a numerical solver, wherein the first calibration physical data is used as the first physical data representing the physical state of the object having the first shape, or the first calibration physical data is used as reference physical data to determine the first physical state data representing the physical state of the object having the first shape using an NN model; when the first condition is not met, the physical state data determination module 1510 determines the first physical state data representing the physical state of the object having the first shape using an NN model. According to one example, the first condition comprises: the difference (e.g., distance) between the first calibration physical data determined by the numerical solver in the most recent time the first condition was met and the first physical data determined by the NN model most recently is greater than a first threshold.

FIG. 16 shows an apparatus for training an NN model for determining the physical state of an object having a shape according to one example.

The apparatus 1600 comprises: a processing module 1610 comprising the NN model, which receives first structural data representing a first shape of a first object and first labeled physical state data representing the physical state of the first object having the first shape; generates a first feature sequence comprising N feature vectors based on the first structural data; converts the first feature sequence into a second feature sequence comprising M feature vectors; performs Fourier transform-based processing on the second feature sequence to obtain a third feature sequence comprising M feature vectors; converts the third feature sequence into a fourth feature sequence comprising N feature vectors; and determines first predicted physical state data representing the physical state of the first object having the first shape based on the fourth feature sequence; and an update module 1620, which updates learnable parameters of the NN model based on the first predicted physical state data and the first labeled physical state data.

According to one example, the processing module 1610 further receives reference structural data representing a reference shape of the first object and reference physical data representing the physical state of the object having the reference shape; and generates the first feature sequence based on the first structural data, the reference structural data, and the reference physical data.

According to one example, the processing module 1610 generates a fifth feature sequence comprising N feature vectors based on the first structural data; generates a sixth feature sequence comprising N feature vectors based on the first structural data and the reference structural data; generates a seventh feature sequence comprising N feature vectors based on the reference physical data; and generates the first feature sequence based on the fifth feature sequence, the sixth feature sequence, and the seventh feature sequence.

According to one example, the processing module 1610 obtains a first weight matrix based on the first feature sequence; and weights and aggregates the N feature vectors in the first feature sequence based on the first weight matrix to obtain the second feature sequence comprising M feature vectors. According to one example, the NN model 1610 obtains a second weight matrix based on the first feature sequence; and weights and aggregates the M feature vectors in the third feature sequence based on the second weight matrix to obtain the fourth feature sequence comprising N feature vectors.

According to one example, the processing module 1610 transforms the N feature vectors in the first feature sequence into N distribution vectors, each of which comprises M distribution elements and constitutes a distribution matrix; and obtains the first weight matrix and the second weight matrix based on the distribution matrix.

According to one example, the processing module 1610, for each distribution element in the distribution matrix, determines the weight element in the first weight matrix corresponding to the distribution element based on each element in the column where the element is located. According to one example, the processing module 1610, for each distribution element in the distribution matrix, determines the weight element in the second weight matrix corresponding to the distribution element based on each element in the row where the element is located.

According to one example, the processing module 1610 receives a first labeled gradient of the optimization objective for the structural optimization of the first object with respect to the first structural data corresponding to the first structural data and the first labeled physical state data; and determines the first gradient of the optimization objective for the structural optimization with respect to the first structural data based on the first predicted physical state data. The update module 1620 updates the learnable parameters of the neural network model based on the first predicted physical state data, the first labeled physical state data, the first gradient, and the first labeled gradient. According to one example, the apparatus 1600 further comprises a loss module that determines a first loss based on the first predicted physical state data and the first labeled physical state data; and determines a second loss based on the first gradient and the first labeled gradient. The update module 1620 updates the learnable parameters of the neural network model based on the first loss and the second loss. According to one example, the first structural data, the first labeled physical state data, and the first labeled gradient are derived from historical optimization trajectory data used to optimize the structure of the first object.

According to one example, the processing module 1610 generates a random value; when the comparison between the random value and a reference discard threshold meets a second condition, it generates the first feature sequence based on the first structural data, the reference structural data, and the reference physical data; when the comparison between the random value and the reference discard threshold does not meet the second condition, it generates the first feature sequence based only on the first structural data.

According to one example, the processing module 1610 receives second structural data representing a second shape of a second object and second labeled physical state data representing a physical state of the second object having the second shape; generates a first feature sequence comprising K feature vectors based on the second structural data of the second object; converts the first feature sequence comprising K feature vectors into a second feature sequence comprising M feature vectors; performs Fourier transform-based processing on the second feature sequence to obtain a third feature sequence comprising M feature vectors; converts the third feature sequence into a fourth feature sequence comprising K feature vectors; and determines second predicted physical state data representing a physical state of the second object having the second shape based on the fourth feature sequence comprising K feature vectors. The update module 1620 updates the learnable parameters of the neural network model based on the second predicted physical state data and the second labeled physical state data.

According to one example, the processing module 1610 receives a second labeled gradient of the optimization objective for the structural optimization of the second object with respect to the second structural data corresponding to the second structural data and the second labeled physical state data; and determines the second gradient of the optimization objective for the structural optimization with respect to the second structural data based on the second predicted physical state data. The update module 1620 updates the learnable parameters of the neural network model based on the second predicted physical state data, the second labeled physical state data, the second gradient, and the second labeled gradient.

FIG. 17 shows an apparatus for structural optimization of an object according to one example.

The apparatus 1700 comprises a physical state data determination module 1710 and a structure update module 1720. The physical state data determination module 1710 receives first structural data representing a first shape of the object; determines whether a first condition is met; when the first condition is met, a numerical solver determines first calibration physical data representing the physical state of the object having the first shape based on the first structural data, wherein the first calibration physical data is used as the first physical data representing the physical state of the object having the first shape, or the first calibration physical data is used as the reference physical data of the first NN model to predict the first physical data representing the physical state of the object having the first shape; when the first condition is not met, the first NN model determines the first physical data representing the physical state of the object having the first shape based on the first structural data, reference structural data representing a reference shape of the object, and reference physical data representing the physical state of the object having the reference shape. The structure update module 1720 updates the first structural data of the object based on the first physical data to obtain updated first structural data representing an updated first shape of the object. The updated first structural data is provided to the physical state data determination module 1710 in the next structural optimization step to iteratively optimize the structure of the object.

According to one example, the first condition comprises: the difference between the first calibration physical data determined by the numerical solver in the most recent time the first condition was met and the first physical data determined by the first NN model most recently is greater than a first threshold.

According to one example, the reference structural data and the reference physical data respectively comprise the first structural data processed by the numerical solver when the first condition was most recently met and the first calibration physical data determined accordingly.

According to one example, the reference structural data and the reference physical data respectively comprise one or more of the first structural data processed by the first NN model in one or more iteration rounds after the first condition was most recently met and one or more of the first physical data determined accordingly.

According to one example, the reference structural data and the reference physical data respectively comprise a plurality of the first structural data processed in a plurality of iteration rounds and a plurality of first physical data determined accordingly. The physical state data determination module 1710 determines a plurality of first temporary physical data representing the physical state of the object having the first shape using the first NN model based on the first structural data, each of the plurality of the first structural data, and each of the plurality of the first physical data determined accordingly; and determines the first physical data based on the plurality of first temporary physical data. For example, the plurality of first temporary physical data is averaged to obtain the first physical data. According to one example, the structure update module 1720 determines a first gradient of the optimization objective of the structural optimization with respect to the first structural data based on the first physical data; and obtains the updated first structural data based on the first structural data and the first gradient.

According to one example, the physical state data determination module 1710 adds noise to the first structural data to obtain a plurality of first structural data instances of the first structural data; the first NN model determines a plurality of first physical data instances representing the physical state of the object having the first shape based on each of the plurality of first structural data instances, the reference structural data, and the reference physical data to serve as the first physical data. The structure update module 1720, based on each of the plurality of first physical data instances, determines a plurality of first gradient instances of the optimization objective of the structural optimization with respect to the first structural data; and determines the first gradient based on the plurality of first gradient instances. For example, the plurality of first gradient instances are averaged to obtain the first gradient.

According to one example, the reference structural data and the reference physical data respectively comprise a plurality of the first structural data processed in a plurality of iteration rounds and a plurality of first physical data determined accordingly. The physical state data determination module 1710, for each of the plurality of first structural data instances: determines a plurality of first temporary physical data representing the physical state of the object having the first shape using the first NN model based on the first structural data instances, each of the plurality of the first structural data, and each of the plurality of the first physical data determined accordingly; and determines a first physical data instance corresponding to the first structural data instance based on the plurality of first temporary physical data to serve as one of the plurality of first physical data instances.

According to one example, the NN model comprises a virtual Fourier layer, the virtual Fourier layer comprising a first transformation layer, a Fourier processing layer, and a second transformation layer. The first transformation layer converts a first feature sequence comprising N feature vectors into a second feature sequence comprising M feature vectors, wherein the first feature sequence is obtained based on the first structural data, the reference structural data, and the reference physical data, and wherein N is not equal to M. The second feature sequence is processed by the Fourier processing layer based on Fourier transform to obtain a third feature sequence comprising M feature vectors. The third feature sequence is converted into a fourth feature sequence comprising N feature vectors through the second transformation layer. According to one example, the conversion of a first feature sequence comprising N feature vectors into a second feature sequence comprising M feature vectors by the first transformation layer comprises: obtaining a first weight matrix based on the first feature sequence; and weighting and aggregating the N feature vectors in the first feature sequence based on the first weight matrix to obtain the second feature sequence comprising M feature vectors.

According to one example, the conversion of the third feature sequence into a fourth feature sequence comprising N feature vectors through the second transformation layer comprises: obtaining a second weight matrix based on the first feature sequence; and weighting and aggregating the M feature vectors in the third feature sequence based on the second weight matrix to obtain the fourth feature sequence comprising N feature vectors.

According to one example, obtaining the first weight matrix based on the first feature sequence comprises: transforming the N feature vectors in the first feature sequence into N distribution vectors, each of which comprises M distribution elements and constitutes a distribution matrix; and obtaining the first weight matrix based on the distribution matrix. Obtaining the second weight matrix based on the first feature sequence comprises: obtaining the second weight matrix based on the distribution matrix.

According to one example, obtaining the first weight matrix based on the distribution matrix comprises: for each distribution element in the distribution matrix, determining the weight element in the first weight matrix corresponding to the distribution element based on each element in the column where the element is located. Obtaining the second weight matrix based on the distribution matrix comprises: for each distribution element in the distribution matrix, determining the weight element in the second weight matrix corresponding to the distribution element based on each element in the row where the element is located.

According to one example, the first NN model further comprises an encoder and a decoder. The encoder generates a fifth feature sequence, a sixth feature sequence, and a seventh feature sequence, each comprising N feature vectors, based on the first structural data, the reference structural data, and the reference physical data. The first feature sequence is generated based on the fifth feature sequence, the sixth feature sequence, and the seventh feature sequence. The decoder predicts the first physical data or the amount of physical data change used to determine the first physical data based on the fourth feature sequence.

FIG. 18 shows a block diagram of a processing apparatus 1800 according to one example.

The processing apparatus or processing system 1800 comprises one or more control units or processing units 1810 that execute one or more machine-readable instructions stored or encoded in a machine-readable storage medium (i.e., the memory 1820). In one example, the processing unit 1810, when executing the program instructions, is configured to perform various operations and functions described above in connection with FIGS. 1 to 17. Those skilled in the art will understand that the apparatus described in the examples of the present disclosure may also comprise various other components, such as various communication modules, bus modules, and possible user interface modules.

According to one example, a machine-readable storage medium is provided. The readable medium may have instructions that, when executed by the processing unit 1810, are capable of performing various operations and functions described above in connection with FIG. 1 to FIG. 17 in various examples of the present disclosure.

According to one example, a computer program product is provided. The computer program product comprises computer-executable instructions that, when executed by the processing unit 1810, are capable of performing various operations and functions described above in connection with FIGS. 1 to 17 in various examples of the present disclosure.

Exemplary examples are described above with reference to the specific examples described in the figures, but do not represent all examples that may be implemented or fall within the scope of protection of the present disclosure. Throughout the present Specification, the term “exemplary” means “serving as an example, instance, or illustration” and does not imply “preferred” or “advantageous” over other examples. Specific examples comprise specific details to facilitate understanding of the described technology. However, these technologies may be implemented without these specific details. In some instances, to avoid causing difficulties in understanding the concepts of the described examples, structures and apparatuses are shown in block diagram form.

The aforementioned description of the present disclosure is provided to allow any person of ordinary skill in the art to implement or use the present disclosure. Various modifications to the present disclosure will be apparent to those of ordinary skill in the art, and the general principles defined herein may be applied to other variations without departing from the scope of protection of the present disclosure. Therefore, the present disclosure is not limited to the exemplary examples and designs described herein but is consistent with the broadest scope defined by the principles and novel features disclosed herein.

What is claimed is:

1. A computer-implemented method for determining a physical state of an object having a shape, the method comprising the following steps:
receiving first structural data representing a first shape of the object;
generating a first feature sequence including N feature vectors based on the first structural data;
converting the first feature sequence into a second feature sequence including M feature vectors;
processing the second feature sequence based on Fourier transform to obtain a third feature sequence including M feature vectors;
converting the third feature sequence into a fourth feature sequence including N feature vectors; and
determining first physical state data representing the physical state of the object having the first shape based on the fourth feature sequence.

2. The method according to claim 1, further comprising:
receiving reference structural data representing a reference shape of the object and reference physical data representing the physical state of the object having the reference shape;
wherein the generating of the first feature sequence including N feature vectors based on the first structural data includes: generating the first feature sequence based on the first structural data, the reference structural data, and the reference physical data.

3. The method according to claim 2, wherein the generating of the first feature sequence includes:
generating a fifth feature sequence including N feature vectors based on the first structural data;
generating a sixth feature sequence including N feature vectors based on the first structural data and the reference structural data;
generating a seventh feature sequence including N feature vectors based on the reference physical data;
generating the first feature sequence based on the fifth feature sequence, the sixth feature sequence, and the seventh feature sequence.

4. The method according to claim 1, wherein the converting of the first feature sequence into the second feature sequence including M feature vectors includes:
obtaining a first weight matrix based on the first feature sequence;
weighting and aggregating the N feature vectors in the first feature sequence based on the first weight matrix to obtain the second feature sequence including M feature vectors;
wherein the conversion of the third feature sequence into the fourth feature sequence including N feature vectors includes: obtaining a second weight matrix based on the first feature sequence;
weighting and aggregating the M feature vectors in the third feature sequence based on the second weight matrix to obtain the fourth feature sequence including N feature vectors.

5. The method according to claim 4, wherein the obtaining of the first weight matrix based on the first feature sequence includes:
transforming the N feature vectors in the first feature sequence into N distribution vectors, each of which includes M distribution elements and constitutes a distribution matrix;
obtaining the first weight matrix based on the distribution matrix;
wherein the obtaining of the second weight matrix based on the first feature sequence includes: obtaining the second weight matrix based on the distribution matrix.

6. The method according to claim 5, wherein:
the obtaining of the first weight matrix based on the distribution matrix includes: for each distribution element in the distribution matrix, determining the weight element in the first weight matrix corresponding to the distribution element based on each element in a column where the distribution element is located;
the obtaining of the second weight matrix based on the distribution matrix includes: for each distribution element in the distribution matrix, determining the weight element in the second weight matrix corresponding to the distribution element based on each element in a row where the element is located.

7. The method according to claim 1, wherein the object includes at least one of: a fuel cell bipolar plate, a part of a car, a part of an airplane, a part of a building, a pipe of a reactor, or a guide plate, and wherein the physical data includes at least one of: velocity, pressure, temperature, electric field, or magnetic field.

8. A computer-implemented method for structural optimization of an object, comprising iteratively performing the following steps:
receiving first structural data representing a first shape of the object;
determining first physical state data representing the physical state of the object having the first shape, the determining including:
generating a first feature sequence including N feature vectors based on the first structural data,
converting the first feature sequence into a second feature sequence including M feature vectors,
processing the second feature sequence based on Fourier transform to obtain a third feature sequence including M feature vectors,
converting the third feature sequence into a fourth feature sequence including N feature vectors, and
determining the first physical state data representing the physical state of the object having the first shape based on the fourth feature sequence;
updating the first structural data based on the first physical state data to obtain updated first structural data representing an updated first shape of the object.

9. The method according to claim 8, wherein the updating of the first structural data based on the first physical state data includes:
determining a first gradient of an optimization objective of the structural optimization with respect to the first structural data based on the first physical state data;
obtaining the updated first structural data based on the first structural data and the first gradient.

10. The method according to claim 8, further comprising:
when a first condition is met, determining first calibration physical data representing the physical state of the object having the first shape based on the first structural data by a numerical solver, wherein: (i) the first calibration physical data is used as the first physical state data representing the physical state of the object having the first shape, or (ii) the first calibration physical data is used as reference physical data to predict first physical state data representing the physical state of the object having the first shape;
wherein the determining of the first physical state data representing the physical state of the object having the first shape includes: when a first condition is not met, performing the determining of the first physical state data representing the physical state of the object having the first shape.

11. The method according to claim 10, wherein the first condition includes: a difference between the first calibration physical data determined by the numerical solver a most recent time the first condition was met and the first physical state data determined most recently is greater than a first threshold.

12. A computer-implemented method for training a neural network model for determining a physical state of an object having a shape, wherein the neural network model includes a virtual Fourier layer, the virtual Fourier layer including a first transformation layer, a Fourier processing layer, and a second transformation layer, the method comprising the following steps:
receiving first structural data representing a first shape of a first object and first labeled physical state data representing the physical state of the first object having the first shape;
generating a first feature sequence including N feature vectors based on the first structural data;
converting the first feature sequence into a second feature sequence including M feature vectors through the first transformation layer;
processing the second feature sequence by the Fourier processing layer based on Fourier transform to obtain a third feature sequence including M feature vectors;
converting the third feature sequence into a fourth feature sequence including N feature vectors through the second transformation layer;
determining first predicted physical state data representing the physical state of the first object having the first shape based on the fourth feature sequence;
updating learnable parameters of the neural network model based on the first predicted physical state data and the first labeled physical state data.

13. The method according to claim 12, further comprising:
receiving reference structural data representing a reference shape of the first object and reference physical data representing the physical state of the object having the reference shape;
wherein the generating of the first feature sequence including N feature vectors based on the first structural data includes: generating the first feature sequence based on the first structural data, the reference structural data, and the reference physical data.

14. The method according to claim 13, wherein the neural network model further includes an encoder and a decoder, wherein the generating of the first feature sequence includes:
generating a fifth feature sequence including N feature vectors based on the first structural data using the encoder;
generating a sixth feature sequence including N feature vectors based on the first structural data and the first reference structural data using the encoder;
generating a seventh feature sequence including N feature vectors based on the reference physical data using the encoder;
generating the first feature sequence based on the fifth feature sequence, the sixth feature sequence, and the seventh feature sequence.

15. The method according to claim 12, wherein the converting pf the first feature sequence into the second feature sequence comprising M feature vectors includes:
obtaining a first weight matrix based on the first feature sequence;
weighting and aggregating the N feature vectors in the first feature sequence based on the first weight matrix to obtain the second feature sequence comprising M feature vectors;
wherein the conversion of the third feature sequence into the fourth feature sequence including N feature vectors includes: obtaining a second weight matrix based on the first feature sequence;
weighting and aggregating the M feature vectors in the third feature sequence based on the second weight matrix to obtain the fourth feature sequence including N feature vectors.

16. The method according to claim 15, wherein the obtaining of the first weight matrix based on the first feature sequence includes:
transforming the N feature vectors in the first feature sequence into N distribution vectors, each of the N distribution vectors including M distribution elements and constitutes a distribution matrix;
obtaining the first weight matrix based on the distribution matrix;
wherein obtaining the second weight matrix based on the first feature sequence includes: obtaining the second weight matrix based on the distribution matrix.

17. The method according to claim 16, wherein the obtaining of the first weight matrix based on the distribution matrix includes: for each distribution element in the distribution matrix, determining the weight element in the first weight matrix corresponding to the distribution element based on each element in a column where the element is located;
wherein obtaining the second weight matrix based on the distribution matrix comprises: for each distribution element in the distribution matrix, determining the weight element in the second weight matrix corresponding to the distribution element based on each element in a row where the element is located.

18. The method according to claim 12, further comprising:
receiving a first labeled gradient of an optimization objective for a structural optimization of the first object with respect to the first structural data corresponding to the first structural data and the first labeled physical state data;
determining a first gradient of the optimization objective of the structural optimization with respect to the first structural data based on the first predicted physical state data;
wherein the updating of learnable parameters of the neural network model based on the first predicted physical state data and the first labeled physical state data includes: updating the learnable parameters of the neural network model based on the first predicted physical state data, the first labeled physical state data, the first gradient, and the first labeled gradient.

19. The method according to claim 18, wherein the first structural data, the first labeled physical state data, and the first labeled gradient are derived from historical optimization trajectory data used to perform the structural optimization of the first object.

20. The method according to claim 13, further comprising:
generating a random value;
generating the first feature sequence based on the first structural data, the reference structural data, and the reference physical data includes:
when a comparison between the random value and a reference discard threshold meets a second condition, generating the first feature sequence based on the first structural data, the reference structural data, and the reference physical data,
when the comparison between the random value and the reference discard threshold does not meet the second condition, generating the first feature sequence based only on the first structural data.

21. The method according to claim 12, further comprising:
receiving second structural data representing a second shape of a second object and second labeled physical state data representing a physical state of the second object having the second shape;
generating a first feature sequence including K feature vectors based on the second structural data of the second object;
converting the first feature sequence including K feature vectors into a second feature sequence including M feature vectors through the first transformation layer;
processing the second feature sequence by the Fourier processing layer based on Fourier transform to obtain a third feature sequence including M feature vectors;
converting the third feature sequence into a fourth feature sequence including K feature vectors through the second transformation layer;
determining second predicted physical state data representing the physical state of the second object having the second shape based on the fourth feature sequence including K feature vectors;
updating learnable parameters of the neural network model based on the second predicted physical state data and the second labeled physical state data.

22. The method according to claim 21, further comprising:
receiving a second labeled gradient of the optimization objective for a structural optimization of the second object with respect to the second structural data corresponding to the second structural data and the second labeled physical state data;
determining a second gradient of an optimization objective of the structural optimization with respect to the second structural data based on the second predicted physical state data;
wherein the updating of the learnable parameters of the neural network model based on the second predicted physical state data and the second labeled physical state data includes: updating the learnable parameters of the neural network model based on the second predicted physical state data, the second labeled physical state data, the second gradient, and the second labeled gradient.

23. An apparatus for determining the physical state of an object having a shape, comprising:
a generation module configured to generate a first feature sequence including N feature vectors based on first structural data representing a first shape of the object;
a virtual Fourier module configured to convert the first feature sequence into a second feature sequence comprising M feature vectors, perform Fourier transform-based processing on the second feature sequence to obtain a third feature sequence including M feature vectors, and convert the third feature sequence into a fourth feature sequence comprising N feature vectors; and
a determination module configured to determine first physical state data representing the physical state of the object having the first shape based on the fourth feature sequence.

24. An apparatus for structural optimization of an object, comprising:
a physical state data determination module configured to determine first physical state data representing a physical state of the object having a first shape based on first structural data representing a first shape of the object by performing:
receiving the first structural data representing the first shape of the object;
generating a first feature sequence including N feature vectors based on the first structural data;
converting the first feature sequence into a second feature sequence including M feature vectors;
processing the second feature sequence based on Fourier transform to obtain a third feature sequence including M feature vectors;
converting the third feature sequence into a fourth feature sequence including N feature vectors; and
determining the first physical state data representing the physical state of the object having the first shape based on the fourth feature sequence;
a structure update module configured to update the first structural data based on the first physical state data to obtain updated first structural data representing an updated first shape of the object.

25. An apparatus for training a neural network model for determining a physical state of an object having a shape, comprising:
a processing module including the neural network model, configured to receive first structural data representing a first shape of a first object and first labeled physical state data representing the physical state of the first object having the first shape, generate a first feature sequence including N feature vectors based on the first structural data, convert the first feature sequence into a second feature sequence including M feature vectors, perform Fourier transform-based processing on the second feature sequence to obtain a third feature sequence including M feature vectors, convert the third feature sequence into a fourth feature sequence including N feature vectors, and determine first predicted physical state data representing the physical state of the first object having the first shape based on the fourth feature sequence; and
an update module configured to update learnable parameters of the neural network model based on the first predicted physical state data and the first labeled physical state data.

26. A processing apparatus, comprising:
one or more processors; and
one or more non-transitory memories having computer-executable instructions stored thereon for determining a physical state of an object having a shape, the instructions, when run by the one or more processors, causing the one or more processors to perform the following steps including:
receiving first structural data representing a first shape of the object,
generating a first feature sequence including N feature vectors based on the first structural data,
converting the first feature sequence into a second feature sequence including M feature vectors,
processing the second feature sequence based on Fourier transform to obtain a third feature sequence including M feature vectors,
converting the third feature sequence into a fourth feature sequence including N feature vectors, and
determining first physical state data representing the physical state of the object having the first shape based on the fourth feature sequence.

27. A non-transitory machine-readable storage medium having executable instructions stored thereon for determining a physical state of an object having a shape, the instructions, when run by one or more processors, causing the one or more processors to perform the following steps including:
receiving first structural data representing a first shape of the object;
generating a first feature sequence including N feature vectors based on the first structural data;
converting the first feature sequence into a second feature sequence including M feature vectors;
processing the second feature sequence based on Fourier transform to obtain a third feature sequence including M feature vectors;
converting the third feature sequence into a fourth feature sequence including N feature vectors; and
determining first physical state data representing the physical state of the object having the first shape based on the fourth feature sequence.
